(19) United States
(12) Patent Application Publication
(10) Pub. No.: US 2011/0026494 A1
(43) Pub. Date: Feb. 3, 2011

(54) WIRELESS COMMUNICATION APPARATUS AND COMMUNICATION APPARATUS

(75) Inventors: Chizuko Nagasawa, Yokohama-shi (JP); Kugo Morita, Yokohama-shi (JP)

Correspondence Address: WORKMAN NYDEGGER;1000 Eagle Gate Tower, 60 East South Temple, Salt Lake City, UT, 84111, US

(73) Assignee: KYOCERA CORPORATION, Kyoto-shi, Kyoto (JP)

(21) Appl. No.: 12/934,586

(22) PCT Filed: Mar. 26, 2009
(86) PCT No.: PCT/JP2009/056178

§ 371 Date: Sep. 24, 2010

(30) Foreign Application Priority Data
Mar. 27, 2008 (JP) 2008-084124
Mar. 27, 2008 (JP) 2008-084131

(51) Int. Cl. H04W 36/14; H04W 36/30; H04W 88/06

(52) U.S. Cl. 370/332; 455/436; 455/552.1

(57) ABSTRACT

In order to perform handover from a first wireless communication network to a second wireless communication network, when it is determined to start preparing for handover from the first wireless communication network to the second wireless communication network, data are transmitted via the first wireless communication network and simultaneously accumulated for a predetermined period. The accumulated data are transmitted via the second wireless communication network after handover. It thus enables to transmit the data in the predetermined period, which are expected to be lost because of handover, while accumulating the data and to transmit accumulated data after handover. Thereby, it is possible to provide a wireless communication apparatus and a communication apparatus capable of performing handover to a different wireless communication network without causing packet loss and thus maintaining stable reproduction quality and real-time property all the time.

### CROSS REFERENCE TO RELATED APPLICATION

This application claims priority to and the benefit of Japanese Patent Applications No. 2008-84124 and No. 2008-84131 filed on Mar. 27, 2008, the entire contents of which are incorporated herein by reference.

### TECHNICAL FIELD

The present invention relates to wireless communication apparatuses capable of performing handover between different wireless communication networks and communication apparatuses for communicating with the wireless communication apparatuses.

### BACKGROUND ART

In recent years, IETF (Internet Engineering Task Force) has been considering an IP mobility scheme which enables handover between a plurality of different wireless communication networks such as a cellular phone network, a wireless LAN and the like, in order to achieve ubiquitous environment (see Non-Patent Document 1, for example). As a specific protocol of the IP mobility scheme, there are known Mobile IPv4 and Mobile IPv6 (these are abbreviated as Mobile IP, hereinafter) for supporting movements of each individual communication terminal, and NEMO (Network Mobility) for supporting mobility of a network as a unit.

For mobile IP and NEMO, when a mobile node (MN) performs handover, the mobile node registers an IP address of a wireless communication network of a handover destination as a care-of address (CoA) to a home agent (HA) which the MN belongs to. Thereby, the mobile node can communicate with a correspondent node (CN) which is a communication counterpart via the wireless communication network of the handover destination.

As for handover methods, there are known an MBB (Make-Before-Break) scheme which connects the MN to a network of the handover destination before disconnecting from a network of a handover source, and a BBM (Break-Before-Make) scheme which connects the MN to the network of the handover destination after disconnecting from the network of the handover source. Since the MBB scheme connects the MN to the wireless communication network seamlessly by switching the network, it is efficient for an application with real-time property, such as VoIP.

Non-Patent Document 1: C. Perkins, “IP Mobility Support (RFC2002)”, [online], October 1996, IETF, [searched on Mar. 15, 2006], Internet <URL: http://www.ietf.org/rfc/rfc2002.txt

### SUMMARY OF INVENTION

### Technical Problem

However, when performing handover by the MBB scheme, the HA receives Registration Request (Binding Update in NEMO), which is handover request information from the MN, and registers CoA of the handover destination, and thereby communication between the MN and the CN is performed via the wireless communication network of the handover destination thereafter. In addition, when receiving Registration Reply (Binding Acknowledge in NEMO), which is handover completion information replied from the HA, the MN disconnects from the wireless communication network of the handover source, and communicates via the wireless communication network of the handover destination thereafter.

That is, at handover by the MBB scheme, the MN transmits packets through the wireless communication network of the handover source even after CoA of the handover destination is registered to the HA, until the MN receives the handover completion information from the HA and starts transmitting packets through the wireless communication network of the handover destination.

Therefore, when a single CoA is registered to the HA and the packets are transmitted from the MN to the CN via the HA, the packets arrived at HA via the wireless communication network of the handover source after CoA of the handover destination is registered to the HA are discarded without being transported to the CN, and thus the packets are lost. An amount of the packets to be lost is increased as an uplink absolute delay time of the wireless communication network of the handover source from the MN to the HA is longer, and also as the downlink absolute delay time of the wireless communication network of the handover destination from the HA to the MN is longer.

As a result, if handover is performed during communication with the application with the real-time property such as VoIP, voice is broken on a CN side causing silence because of packet loss, which leads to deterioration of reproduction quality and real-time property.

In addition, when the single CoA is registered to the HA and the transmission packets from the CN is transferred to the MN, since the MN switches the wireless communication network based on the handover completion information from the handover destination, if the downlink absolute delay time of the handover source is longer than that of the handover destination, packet loss is caused because packets transmitted from the HA via the wireless communication network of the handover source cannot be received after switching and disconnecting from the wireless communication network of the handover source. An amount of packet loss is increased as the downlink absolute delay time of the wireless communication network of the handover source from the HA to the MN is longer than that of the wireless communication network of the handover destination.

As a result, if handover is performed during communication with the real-time application such as VoIP, voice is broken causing silence because of packet loss on the MN side as well, leading to deterioration of reproduction quality and real-time property.

In order to prevent that silence occurs because of packet loss, it may be considered to perform reproduction processing so as to connect voice before and after packet loss, for example. However, this case may give a user a sense of discomfort by a discontinuous sentence.

Therefore, a first object of the present invention in consideration of such problems is to provide a wireless communication apparatus capable of performing handover to a different wireless communication network without causing packet loss, and maintaining stable reproduction quality and real-time property all the time.

In addition, a second object of the present invention is to provide a communication apparatus capable of transmitting packets to a wireless communication apparatus, which performs handover to the different wireless communication network, without causing packet loss, and maintaining stable reproduction quality and real-time property all the time.

### Solution to Problem

In order to achieve the above first object, a wireless communication apparatus according to a first aspect includes:

a wireless communication unit for executing wireless communication by connecting to a first wireless communication network and a second wireless communication network different from the first wireless communication network;

an execution unit for executing an application for real-time communication via the wireless communication unit;

a communication quality obtaining unit for obtaining communication quality of a wireless link in the first wireless communication network during execution of the application by connecting to the first wireless communication network;

a determination unit for determining whether to start handover preparation from the first wireless communication network to the second wireless communication network based on the communication quality obtained by the communication quality obtaining unit; and

a control unit, when the determination unit determines to start handover preparation, for controlling so as to transmit data via the first wireless communication network and accumulate the data for a predetermined period, and to transmit the accumulated data via the second wireless communication network after handover.

A second aspect of the present invention is the wireless communication apparatus according to the first aspect further including

an estimation unit, when the determination unit determines to start handover preparation during execution of the application, for estimating a handover preparation time before start of handover based on the communication quality obtained by the communication quality obtaining unit; and

a measuring unit, when the determination unit determines to start handover preparation, for measuring a delay time of each of the first wireless communication network and the second wireless communication network, wherein

the control unit determines a time to start accumulating the data based on the delay time of each of the first wireless communication network and the second wireless communication network measured by the measuring unit and the handover preparation time estimated by the estimation unit.

A third aspect of the present invention is the wireless communication apparatus according to the first aspect further including

a measuring unit, when the determination unit determines to start handover preparation, for measuring a delay time of each of the first wireless communication network and the second wireless communication network, wherein

the control unit determines the predetermined period to accumulate the data based on the delay time of each of the first wireless communication network and the second wireless communication network measured by the measuring unit.

A fourth aspect of the present invention is the wireless communication apparatus according to the first, second or third aspect further including

an encoding unit for encoding transmission data, wherein

the encoding unit encodes the data to be accumulated at a rate lower than an encoding bit-rate used before the determination unit determines to start handover preparation.

In order to achieve the above second object, a communication apparatus according to a fifth aspect includes:

a communication unit for executing communication by connecting to a communication network;

an execution unit for executing an application for real-time communication via the communication unit; and

a control unit, if handover information that a wireless communication apparatus, which is a communication counterpart of the application, performs handover from a first wireless communication network being used for communication to a second wireless communication network different from the first wireless communication network is received from the wireless communication apparatus, for controlling so as to transmit data via the communication network and accumulate the data for a predetermined period, and to transmit the accumulated data to the wireless communication apparatus after handover of the wireless communication apparatus.

A sixth aspect of the present invention is that, in the wireless communication apparatus according to the fifth aspect,

the control unit determines a time to start accumulating the data based on a handover preparation time and a delay time of each of the first wireless communication network and the second wireless communication network, which are included in the handover information, and a delay time of the communication network.

A seventh aspect of the present invention is that, in the wireless communication apparatus according to the fifth aspect,

the control unit determines the predetermined period to accumulate the data based on a delay time of each of the first wireless communication network and the second wireless communication network included in the handover information.

An eighth aspect of the present invention is that, in the wireless communication apparatus according to the sixth aspect,

the control unit determines the predetermined period to accumulate the data based on a delay time of each of the first wireless communication network and the second wireless communication network included in the handover information.

A ninth aspect of the present invention is the wireless communication apparatus according to fifth, sixth, seventh or eighth aspect further including

an encoding unit for encoding transmission data, wherein

the encoding unit encodes the data to be accumulated at a rate lower than an encoding bit-rate used before the handover information is received.

### Advantageous Effects on Invention

The wireless communication apparatus according to the present invention, if it is determined to start handover preparation from the first wireless communication network to the second wireless communication network, transmits data via the first wireless communication network while accumulating the data for a predetermined period, and transmits the accumulated data via the second wireless communication network after handover. It thus enables to accumulate the data in the predetermined period, which are expected to be lost because of handover, while transmitting the data and to transmit the accumulated data after handover. Thereby, it is possible to perform handover to a different wireless communication network without causing packet loss, so that stable reproduction quality and real-time property are maintained all the time.

In addition, if receiving handover information that a wireless communication apparatus, which is a communication counterpart, performs handover from the first wireless communication network being used currently for communication to the second wireless communication network, from the wireless communication apparatus, the communication apparatus of the present invention transmits data to the wireless communication apparatus while accumulating the data for a predetermined period, and transmits the accumulated data to the wireless communication apparatus after handover. Therefore, based on the handover information from the wireless communication apparatus, the communication apparatus can transmit and simultaneously accumulate the data for the predetermined period, which are expected to be lost when the wireless communication apparatus performs handover to the different wireless communication network, and transmit the accumulated data after handover. Thereby, it is possible to maintain stable reproduction quality and real-time property all the time without causing packet loss.

### BRIEF DESCRIPTION OF DRAWINGS

FIG. 1 is a diagram illustrating a schematic constitution of a communication network which a wireless communication apparatus according to a first embodiment of the present invention can use;

FIG. 2 is a block diagram illustrating a schematic constitution of the wireless communication apparatus shown in FIG. 1;

FIG. 3 is a functional block diagram illustrating a schematic constitution of a telephone function unit of the wireless communication apparatus shown in FIG. 2;

FIG. 4 is diagrams illustrating methods to calculate a handover preparation time by a handover control unit shown in FIG. 2;

FIG. 5 is a diagram illustrating an example of a method to obtain absolute delay time;

FIG. 6 is a table showing an example of a conversion table of a radio state and throughput stored in the handover control unit shown in FIG. 2;

FIG. 7 is a sequence diagram illustrating a handover processing between the wireless communication apparatus and an HA shown in FIG. 1;

FIG. 8 is a diagram illustrating occurrence of packet loss by the handover processing shown in FIG. 7;

FIG. 9 is a diagram illustrating a summary of a data transmission processing of a telephone function unit shown in FIG. 2 at handover;

FIG. 10 is a flowchart illustrating operations of a transmission control unit shown in FIG. 3 at handover;

FIG. 11 shows diagrams illustrating states of transmission and reception packets between the wireless communication apparatus shown in FIG. 1 and a communication apparatus when the wireless communication apparatus performs transmission control at handover;

FIG. 12 shows diagrams illustrating states of transmission and reception packets between the wireless communication apparatus and the communication apparatus when the wireless communication apparatus does not perform the transmission control at handover;

FIG. 13 is a functional block diagram illustrating a schematic constitution of the communication apparatus shown in FIG. 1;

FIG. 14 is a functional block diagram illustrating a schematic constitution of a telephone function unit shown in FIG. 13;

FIG. 15 is a sequence diagram illustrating operations of a main section of a telephone function unit shown in FIG. 14;

FIG. 16 is a sequence diagram illustrating flow of handover information among the wireless communication apparatus, the HA and the communication apparatus shown in FIG. 1;

FIG. 17 is a flowchart illustrating operations of a reproduction speed calculation unit shown in FIG. 14;

FIG. 18 shows diagrams illustrating reproduction control of the packets by the communication apparatus shown in FIG. 1;

FIG. 19 is a diagram illustrating an example of a reproduction speed control method for the reception packets by a jitter buffer control unit shown in FIG. 14;

FIG. 20 is a diagram illustrating a schematic constitution of a communication network which a communication apparatus according to a second embodiment of the present invention can use;

FIG. 21 is a block diagram illustrating a schematic constitution of a wireless communication apparatus shown in FIG. 20;

FIG. 22 is a sequence diagram illustrating a handover processing between the wireless communication apparatus and an HA shown in FIG. 20;

FIG. 23 is a diagram illustrating occurrence of packet loss by the handover processing shown in FIG. 22;

FIG. 24 is a functional block diagram illustrating a schematic constitution of the communication apparatus shown in FIG. 20;

FIG. 25 is a functional block diagram illustrating a schematic constitution of a telephone function unit shown in FIG. 24;

FIG. 26 is a diagram illustrating a summary of a data transmission processing by a telephone function unit shown in FIG. 25 at handover;

FIG. 27 is a flowchart illustrating operations of a transmission control unit shown in FIG. 25 at handover;

FIG. 28 shows diagrams illustrating states of reception packets of the wireless communication apparatus if the communication apparatus shown in FIG. 20 performs transmission control at handover;

FIG. 29 shows diagrams illustrating states of the reception packets of the wireless communication apparatus if the communication apparatus does not perform the transmission control at handover;

FIG. 30 is a function al block diagram illustrating a schematic constitution of a telephone function unit of the wireless communication apparatus shown in FIG. 21;

FIG. 31 is a sequence diagram illustrating operations of a main section of a telephone function unit shown in FIG. 30; and

FIG. 32 shows diagrams illustrating reproduction control of packets by the wireless communication apparatus shown in FIG. 20.

### REFERENCE SIGNS LIST

11 wireless communication apparatus
12 communication apparatus
12a handset
15 first wireless communication network
15a base station
16 second wireless communication network
16a access point
18 internet
21, 22, 24 SIP server
23 Home Agent (HA)
31 first wireless I/F
32 second wireless I/F
33 telephone function unit
34 communication processing unit
35 radio information obtaining unit
36 handover control unit
44 encoder
47 jitter buffer
50 jitter buffer monitoring unit
51 jitter buffer control unit
55 handover information obtaining unit
56 transmission control unit
57 transmission buffer
61 measuring server
62 first information server
63 second information server
121 wireless communication apparatus
122 communication apparatus
122a handset
144 encoder
147 jitter buffer
150 jitter buffer monitoring unit
151 jitter buffer control unit
155 handover information obtaining unit
156 transmission control unit
157 transmission buffer
181 network I/F
182 communication processing unit
83 telephone function unit

### DESCRIPTION OF EMBODIMENTS

Embodiments of the present invention will be described with reference to the accompanying drawings.

### First Embodiment

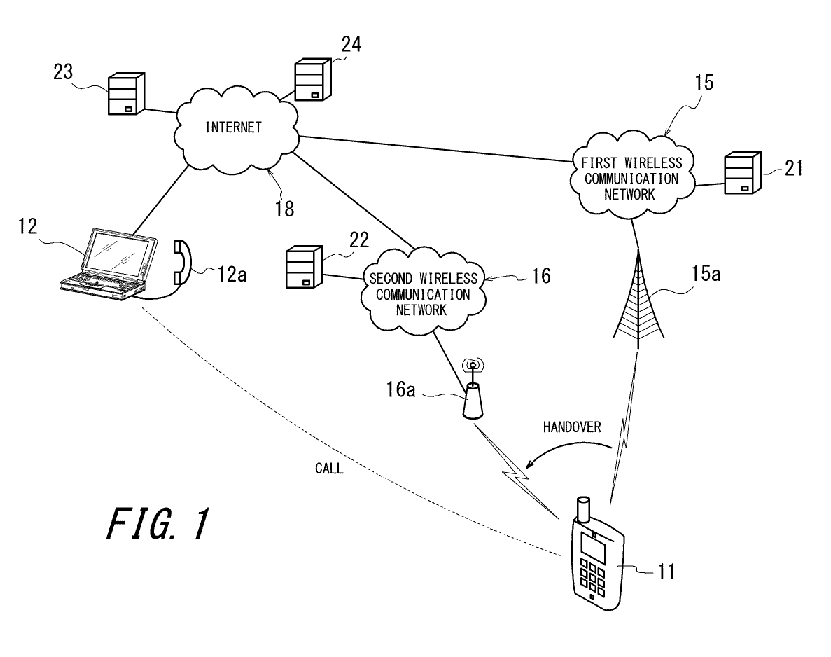

FIG. 1 is a diagram illustrating a schematic constitution of a communication network which a wireless communication apparatus according to a first embodiment of the present invention can use. In FIG. 1, a wireless communication apparatus (MN) 11, which is a mobile node, calls a communication apparatus (CN) 12, which is a correspondent node, by using VoIP which is an application for real-time communication. The wireless communication apparatus 11 can perform handover between a first wireless communication network 15 and a second wireless communication network 16. The first wireless communication network 15 and the second wireless communication network 16 are connected to the internet 18.

Here, for example, it is assumed that the first wireless communication network 15 is a mobile phone network of CDMA2000 1×EV-DO (Code Division Multiple Access 2000 1× Evolution Data Only) and the second wireless communication network 16 is wireless LAN (Local Area Network). It is also assumed that an uplink absolute delay time of the second wireless communication network 16 is shorter than that of the first wireless communication network 15. In FIG. 1, a reference sign 15a represents a base station of the first wireless communication network 15, whereas a reference sign 16a represents an access point of the second wireless communication network 16.

The communication terminal 12 may be a personal computer, for example, having a handset 12a connected thereto and a softphone installed therein as a telephone function unit, and is connected to the internet 18 via an internet service provider (not shown).

The first wireless communication network 15 and the second wireless communication network 16 are connected to SIP (Session Initiation Protocol) servers 21 and 22, respectively, for controlling communication. In addition, a Home Agent (HA) 23, for transferring reception packets addressed to the wireless communication apparatus 11 to a wireless communication network to which the wireless communication apparatus 11 is connected, and an SIP server 24 for controlling communication are connected to the internet 18.

In the communication network shown in FIG. 1, a home address used in the wireless communication network to which the wireless communication apparatus 11 originally belongs is registered to the HA 23, and an IP address of the wireless communication network of a handover destination is also registered as a care-of address (CoA) to the HA 23 at handover. Thereby, the wireless communication apparatus 11 can perform handover between different wireless communication networks. Since such IP mobility techniques are known for Mobile IP and NEMO stated above, detailed description thereof is omitted here.

In FIG. 1, it is assumed that the wireless communication apparatus 11 performs handover to the second wireless communication network 16 in a state that the wireless communication apparatus 11 registers an IP address of the first wireless communication network 15 as a care-of address (first wireless CoA) to the HA 23 and communicates with the communication apparatus 12 via the first wireless communication network 15.

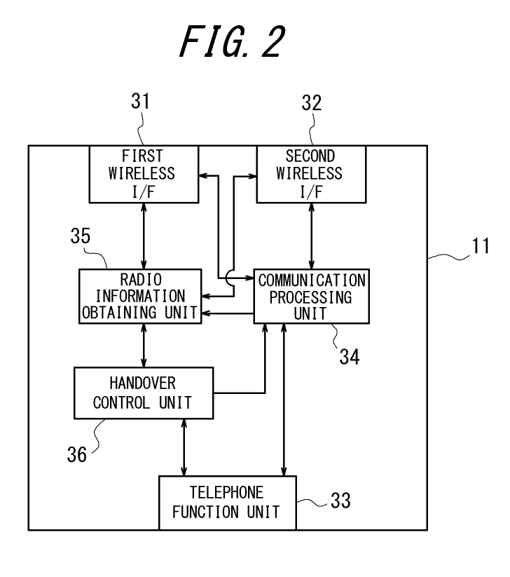

FIG. 2 is a functional block diagram illustrating a schematic constitution of the wireless communication apparatus 11 according to the present embodiment shown in FIG. 1. The wireless communication apparatus 11 includes a first wireless I/F (interface) 31 corresponding to the first wireless communication network 15, a second wireless I/F 32 corresponding to the second wireless communication network 16, a telephone function unit 33 for executing VoIP application, a communication processing unit 34 for controlling connection to the first wireless communication network 15 and the second wireless communication network 16, a radio information obtaining unit 35 for obtaining radio information of the first wireless communication network 15 and the second wireless communication network 16, and a handover control unit 36 for controlling handover between the first wireless communication network 15 and the second wireless communication network 16.

The communication processing unit 34 constitutes a wireless communication unit for performing wireless communication and controls connection of the first wireless I/F 31 or the second wireless I/F 32 such that the telephone function unit 33 and the communication apparatus 12 communicates each other via the first wireless communication network 15 or the second wireless communication network 16 and communicate with the HA 23 under control of the handover control unit 36.

The radio information obtaining unit 35 obtains communication quality of the first wireless communication network 15 and the second wireless communication network 16 as radio information from the first wireless I/F 31 and the second wireless I/F 32, correspondingly, and provides the communication quality obtained to the handover control unit 36. Here, RSSI (Received Signal Strength Indicator) indicating the radio state is obtained as the communication quality. Accordingly, the radio information obtaining unit 35 constitutes a communication quality obtaining unit for obtaining the communication quality of a wireless link.

The handover control unit 36 generates handover information including a determination whether to schedule handover, that is, whether to start handover preparation, based on the communication quality from the radio information obtaining unit 35, and then controls handover based on the handover information.

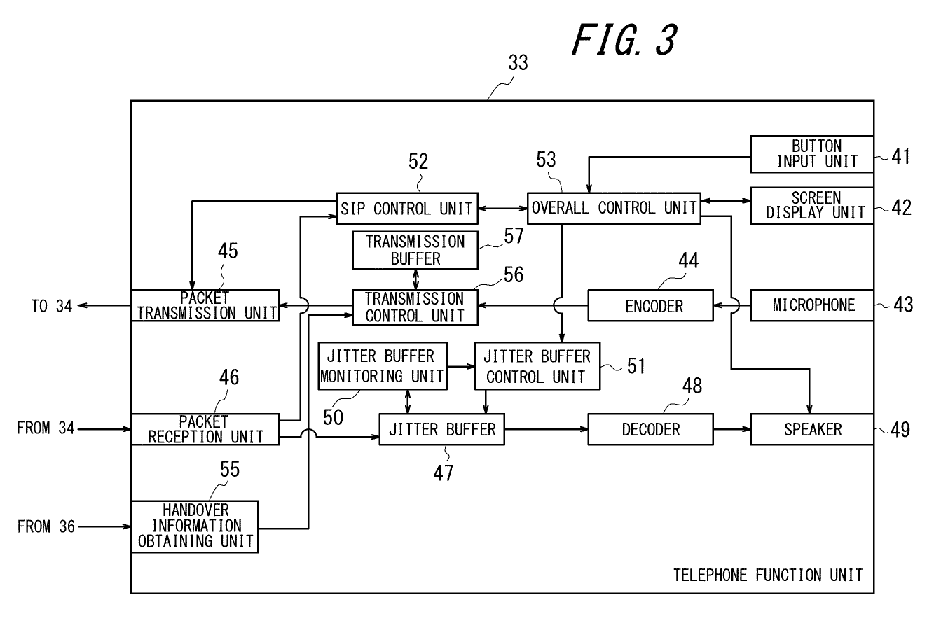

FIG. 3 is a functional block diagram illustrating a schematic constitution of the telephone function unit 33 of the wireless communication apparatus 11 shown in FIG. 2. The telephone function unit 33 may be a softphone, for example, and, in the same manner as the configuration of a known softphone, has a button input unit 41, a screen display unit 42, a microphone 43, an encoder 44, a packet transmission unit 45, a packet reception unit 46, a jitter buffer 47, a decoder 48, a speaker 49, a jitter buffer monitoring unit 50, a jitter buffer control unit 51, an SIP control unit 52, and an overall control unit 53 for controlling the overall operation.

The overall control unit 53 obtains operation information by a user via the button input unit 41 or the screen display unit 42 and controls the overall operation based on the information obtained. The SIP control unit 52 controls SIP procedure to start or end a call. During the call, audio data obtained from the microphone 43 are encoded by the encoder 44, which is an encoding unit, and encoded data are inserted into packets by the packet transmission unit 45 and then transmitted to the communication apparatus 12 via the communication processing unit 34.

Packets from the communication apparatus 12 received by the packet reception unit 46 via the communication processing unit 34 are once stored in the jitter buffer 47 and then read out. Payloads of the packets read out are decoded by the decoder 48 and output as reproduced voice from the speaker 49. A packet receiving state of the jitter buffer 47 and the number of packets (data amount) in the jitter buffer 47 are monitored by the jitter buffer monitoring unit 50 and, based on a result of monitoring, the jitter buffer control unit 51 controls a speed to read out the packets from the jitter buffer 47 and processing to discard received packets.

In the wireless communication apparatus 11 according to the present embodiment, the telephone function unit 33 further includes a handover information obtaining unit 55, a transmission control unit 56 and a transmission buffer 57. The handover information obtaining unit 55 monitors the handover information from the handover control unit 36 at predetermined intervals so as to obtain handover schedule determination information to determine the handover schedule. If the handover schedule determination information is obtained, the handover information obtaining unit 55 further obtains required handover information from the handover control unit 36 and provides the required handover information to the transmission control unit 56.

The transmission control unit 56 controls encoding bit-rate of transmission data by the encoder 44 and transmission of the data from the encoder 44 to the packet transmission unit 45. That is, the transmission control unit 56 transmits the data encoded by the encoder 44 directly to the packet transmission unit 45 in a normal call state in which the handover information is not provided from the handover information obtaining unit 55. In contrast, if the handover information is provided from the handover information obtaining unit 55, the transmission control unit 56 controls so as to accumulate the data from the encoder 44 expected to be lost by handover in the transmission buffer 57 based on the handover information and to transmit such accumulated data to the packet transmission unit 45 after completion of handover. Transmission control by the transmission control unit 56 will be further described below.

Accordingly, the telephone function unit 33 of the wireless communication apparatus 11 according to the present embodiment constitutes an execution unit for executing an application for the real-time communication and a control unit for controlling transmission of the data of the application.

The following is a description of operations of the wireless communication apparatus 11 according to the present embodiment.

First, operations of the handover control unit 36 are mainly described. The handover control unit 36 determines the handover schedule based on the communication quality obtained from the first wireless I/F 31 and the second wireless I/F 32 via the radio information obtaining unit 35. For example, if the communication quality obtained from the first wireless I/F 31 becomes lower than a handover schedule determination threshold and the communication quality obtained from the second wireless I/F 32 becomes equal to or higher than the handover schedule determination threshold during the call performed by forming the wireless link with the first wireless communication network 15, the handover control unit 36 determines the handover schedule to the second wireless communication network 16, that is, to start handover preparation. The communication quality of the second wireless communication network 16 not being used for the call is obtained (measured) by receiving notification information transmitted from the access point 16a, for example.

After determining the handover schedule, the handover control unit 36 obtains a handover preparation time Ts (sec), which is a time before transmitting Registration Request (Binding Update in NEMO) as handover request information, an uplink absolute delay time Tdup1 (sec) of the wireless communication network currently being used (here, the first wireless communication network 15) between the wireless communication apparatus 11 and the HA 23, an uplink absolute delay time Tdup2 (sec) and a downlink absolute delay time Tddn2 (sec) of the wireless communication network of the handover destination (here, the second wireless communication network 16) between the wireless communication apparatus 11 and the HA 23, and an uplink expected bandwidth Rbup2 (bps) of the wireless communication network of the handover destination after completion of handover.

Then, the handover control unit 36 provides such obtained information as the required handover information to the telephone function unit 33, including the handover schedule determination information indicating determination on the handover schedule. The telephone function unit 33 transmits required handover information as a handover notification message, among the handover information obtained from the handover control unit 36, to the communication apparatus 12 via the HA 23. Therefore, the handover control unit 36 of the wireless communication apparatus 11 according to the present embodiment constitutes a determination unit for determining whether to start handover preparation, an estimation unit for estimating the handover preparation time and a measuring unit for measuring a delay time of each of the first wireless communication network 15 and the second wireless communication network 16.

Next, methods for the handover control unit 36 to obtain the handover preparation time Ts, the uplink absolute delay time Tdup1 of the handover source, the uplink and downlink absolute delay times Tdup1 and Tddn2 of the handover destination, and the expected bandwidth Rbup2 of the handover destination are described.

(Method to Obtain Handover Preparation time Ts)

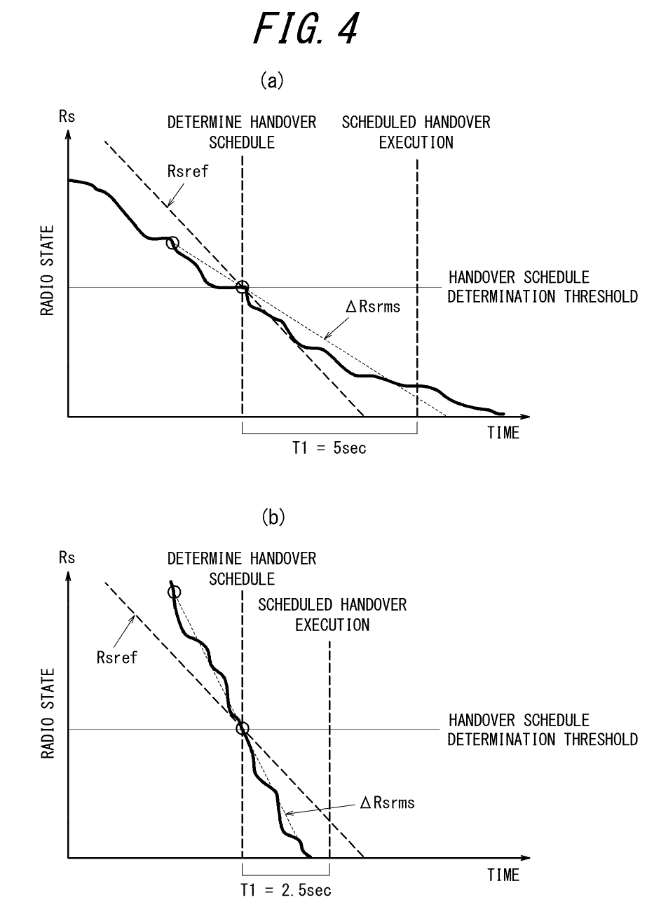

The handover preparation time Ts, as shown in FIGS. 4(a) and (b) for example, is calculated based on a change rate ΔRs (slope) of a radio state (Rs) in a unit time which determines the communication quality. Here, although the change rate ΔRs can be obtained by being measured at a point when handover schedule is determined as the radio state becomes lower than the handover schedule determination threshold, an average change rate ΔRsrms is obtained over a period from a predetermined time before the handover schedule is determined to the time when the handover schedule is determined during the call, in the present embodiment.

Consequently, the handover control unit 36 calculates the change rate ΔRs(t) in the unit time (Δt) of the radio state of the wireless communication network currently being used, by a following formula at a predetermined timing, and stores a plurality of change rates ΔRs(t) to a predetermined time before (for example, 2 seconds before) in a memory. Then, when the handover schedule is determined, the handover control unit 36 calculates the average change rate ΔRsrms over a period to the predetermined time before, from change rates stored at the timing. Here, it is assumed that the radio state is gradually deteriorated.

ΔRs(t)=|{Rs(t)−Rs(t−Δt)}/Δt| [Formula 1]

Subsequently, the handover control unit 36 determines whether the average change rate ΔRsrms calculated is smaller than a change rate threshold Rsref determined in advance. As a result, if ΔRsrms≦Rsref is satisfied, that is, if the radio state changes gently, the handover preparation time Ts is set to a reference time Tref (5 seconds, for example) determined in advance, as shown in FIG. 4(a).

In contrast, if ΔRsrms>Rsref is satisfied, that is, if the radio state changes rapidly, Ts=Tref (Rsref/ΔRsrms) is calculated, for example, and the handover preparation time Ts is set to be shorter than the reference time Tref, as the average change rate ΔRsrms is greater. FIG. 4(b) shows a case where ΔRsrms>Rsref is satisfied and the handover preparation time Ts is set to be approximately half of the reference time Tref (2.5 seconds).

(Methods to Obtain Absolute Delay Times Tdup1, Tdup2, Tddn2)

The uplink absolute delay time Tdup1 of the handover source between the wireless communication apparatus 11 and the HA 23, the uplink and downlink absolute delay times Tdup2 and Tddn2 of the handover destination are obtained by one of first to third methods to obtain absolute delay time described below.

(a) First Method to Obtain Absolute Delay Time

After determining the handover schedule, the handover control unit 36 transmits measuring packets having transmission time stamps to the HA 23, which is temporally synchronized with the wireless communication apparatus 11, via the first wireless I/F 31 and the second wireless I/F 32, and requests the HA 23 to transmit measuring packets having transmission time stamps, reception time stamps by the HA 23 and reply time stamps from the HA 23. Thereby, the HA 23 transmits the measuring packets through both of the first wireless communication network 15 and the second wireless communication network 16. The wireless communication apparatus 11 receives the measuring packets transmitted from the HA 23 via the first wireless I/F31 and the second wireless I/F32 correspondingly and measures the absolute delay times Tdup1, Tdup2 and Tddn2 of corresponding networks based on reception times of the measuring packets and time stamps thereof.

(b) Second Method to Obtain Absolute Delay Time

After determining the handover schedule, the handover control unit 36 controls the wireless communication apparatus 11 to transmit measuring packets, such as PING, RTCP and the like, from both of the first wireless communication network 15 and the second wireless communication network 16 to the HA 23, which is temporally synchronized with the wireless communication apparatus 11, and then by receiving replies, measures the absolute delay times Tdup1, Tdup2 and Tddn2 of corresponding networks.

(c) Third Method to Obtain Absolute Delay Time

After determining the handover schedule, the handover control unit 36 obtains the absolute delay time of each wireless communication network by using a handover scheme considered for IEEE 802.21. For IEEE 802.21 (Media Independent Handover (MIH)), as the handover scheme between different wireless networks (such as WiFi (Wireless Fidelity), WiMAX (Worldwide Interoperability for Microwave Access), a cellular phone and the like), it is considered that means for controlling handover (handover control unit 36 in FIG. 2) is defined as an MIH user and MIHF (MIH Function) obtains radio information of a communication device based on a request by the MIH user and provides the MIH user with the radio information. It is also considered that the MIH user obtains the information from an information server in the network being connected, through MIHF of its own terminal.

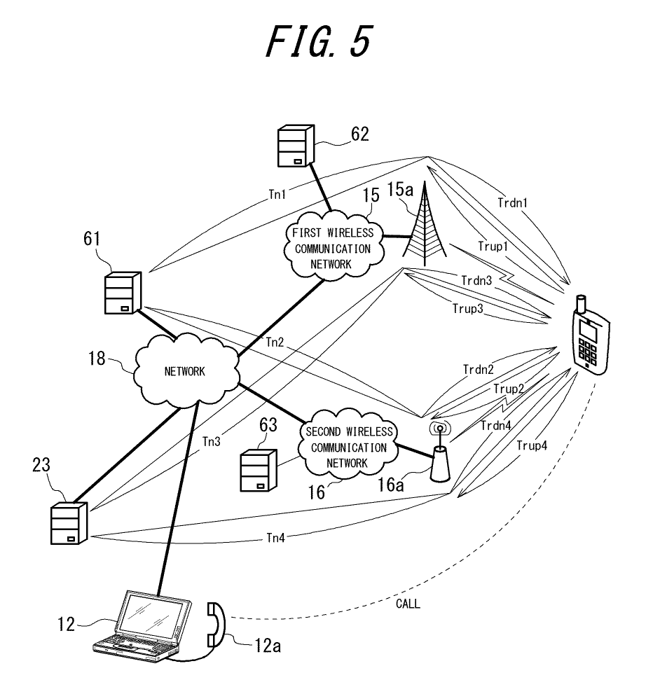

FIG. 5 is a diagram illustrating the third method to obtain the absolute delay time. In FIG. 5, a measuring server 61 for operating to measure the absolute delay time is connected to the internet 18, which is a backbone network. In addition, a first information server 62 and a second information server 63 are connected to the first wireless communication network 15 and the second wireless communication network 16, respectively.

The first information server 62 stores a network delay reference time Tn1 from the measuring server 61, which is directly connected to the internet 18, to the base station 15a, and uplink and downlink wireless delay reference times Trup1 and Trdn1 from the base station 15a to the wireless communication apparatus 11, as references for measuring the delay times. Similarly, the second information server 63 stores a network delay reference time Tn2 from the measuring server 61 to the access point 16a and uplink and downlink wireless delay reference times Trup2 and Trdn2 from the access point 16a to the wireless communication apparatus 11.

Here, the network delay reference times Tn1 and Tn2 are obtained by measuring round trip times between the base station 15a and the measuring server 61 and between the access point 16a and the measuring server 61, respectively, by transmitting and receiving packets (PING, RTCP and the like) and dividing the round trip time by 2.

In addition, in order to calculate the uplink and downlink wireless delay reference times Trup1 and Trdn1 of the first wireless communication network 15, the base station 15a transmits packets to the wireless communication apparatus 11, and the wireless communication apparatus 11 which received the packets records the reception times and then sends back the packets. Accordingly, respective delay times on uplink and downlink are calculated based on the transmission and reception times between the base station 15a and the wireless communication apparatus 11.

Similarly, in order to calculate the uplink and downlink wireless delay reference times Trup2 and Trdn2 of the second wireless communication network 16, the access point 16a transmits packets to the wireless communication apparatus 11, and the wireless communication apparatus 11 which received the packets records the reception time and then sends back the packets. Accordingly, respective delay times on uplink and downlink are calculated based on the transmission and reception times between the access point 16a and the wireless communication apparatus 11. Tdup1 and Trup2 represent the uplink wireless delay reference times, whereas Trdn1 and Trdn2 represent the downlink wireless delay reference times.

The handover control unit 36 of the wireless communication apparatus 11 obtains the network delay reference time Tn1 and the wireless delay reference times Trdn1 and Tdup1 from the first information server 62, connected to the first wireless communication network 15, via MIHF when connecting to the first wireless communication network 15 of the handover source. In addition, the handover control unit 36 transmits and receives packets to/from a counterpart to which a delay time is desired to be measured (here, the HA 23), and measures a round trip time (Tn3+Trdn3+Tn3+Trup3) between the counterpart and the wireless communication apparatus 11 of its own. Then, the handover control unit 36 obtains a one-way delay time (Tn3−Tn1) between the HA 23 and the internet 18 by using a value of the round trip time as shown below, and calculate Tn3+Trup3, which corresponds to the uplink absolute delay time Tdup1 of the handover source between the wireless communication apparatus 11 and the HA 23.

Tn3−Tn1={(Tn3+Trdn3+Tn3+Trup3)−(Tn1+Trdn1+Tn1+Trup1)}/2 Tdup1=Tn3+Trup3=Tn1+Trup1+(Tn3−Tn1) [Formula 2]

It is to be noted that Tn3+Trdn3, corresponding to the downlink absolute delay time Tddn1 of the handover source between the wireless communication apparatus 11 and the HA 23, may be calculated by Tn3+Trdn3=Tn1+Trdn1+(Tn3−Tn1).

In addition, the handover control unit 36 obtains the network delay reference time Tn2 and the wireless delay reference times Trup2, Trdn2 of the handover destination. Therefore, the handover control unit 36 transmits a location information of the wireless communication apparatus 11 to the second information server 63 of the second wireless communication network 16 of the handover destination via the first information server 62 of the first wireless communication network 15, which is being connected currently, and requests the network delay reference time Tn2 and the wireless delay reference times Trup2, Trdn2. Thereby, the second information server 63 transmits the network delay reference time Tn2 and the wireless delay reference times Trup2, Trdn2 of the access point 16a to which the wireless communication apparatus 11 is expected to connect, to the wireless communication apparatus 11 via the first information server 62, in consideration of the location information and the number of connected users of each access point.

The handover control unit 36 receives the network delay reference time Tn2 and the wireless delay reference times Trup2, Trdn2 of the handover destination transmitted from the second information server 63 and, by using such obtained information and (Tn3−Tn1) calculated, calculates Tn4+Trup4, which corresponds to the uplink absolute delay time Tdup2 of the handover destination between the wireless communication apparatus 11 and the HA 23 and Tn4+Trdn4, which corresponds to the downlink absolute delay time Tddn2, as follows.

Tdup2=Tn4+Trup4=(Tn2+Trup2)+(Tn3−Tn1) Tddn2=Tn4+Trdn4=(Tn2+Trdn2)+(Tn3−Tn1) [Formula 3]

The handover control unit 36 stores the absolute delay times Tdup1, Tdup2 and Tddn2, obtained by one of the above first to third methods to obtain absolute delay time, in a memory (not shown) in the handover control unit 36, for each wireless communication network.

(Method to Obtain Expected Bandwidth Rbup2 of Handover Destination)

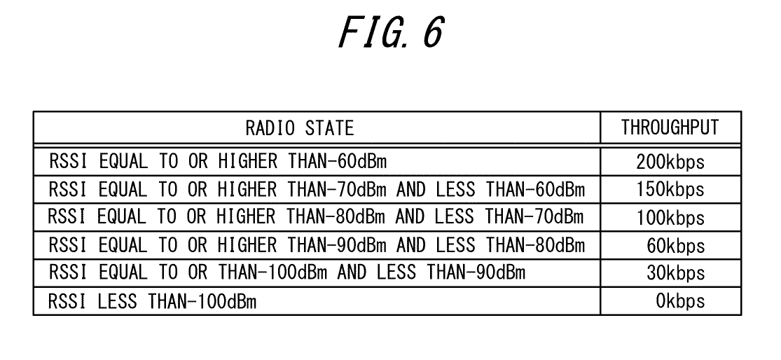

The uplink expected bandwidth Rbup2 of the handover destination is obtained by expecting the radio state of the uplink of the wireless communication network of the handover destination after completion of handover. Therefore, a conversion table of the radio state (communication quality) and throughput (expected bandwidth) as shown in FIG. 6, for example, is stored in the handover control unit 36 in advance. The handover control unit 36 linearly expects the radio state of the handover destination at completion of handover based on the radio state of the handover destination at a point when the handover schedule is determined and the radio state of the handover destination at a predetermined time before the point, for example, and obtains the expected bandwidth Rbup2 of the handover destination at completion of the handover from the conversion table shown in FIG. 6 based on the radio state expected. Here, the point of handover completion is a time corresponding to a sum of the handover preparation time Ts and the absolute delay time (Trup2+Trdn2) of a round trip of the wireless communication network of the handover destination (here, the second wireless communication network 16) between the HA 23 and the wireless communication apparatus 11, after the point to determine the handover schedule.

As set forth above, the handover control unit 36 obtains the handover preparation time Ts, the uplink absolute delay time Tdup1 of the handover source, the uplink and downlink absolute delay times Tdup2 and Tddn2 of the handover destination, and the expected bandwidth Rbup2 of the handover destination and provides such obtained information to the telephone function unit 33.

In addition, if the handover schedule is determined, the handover control unit 36 performs handover processing.

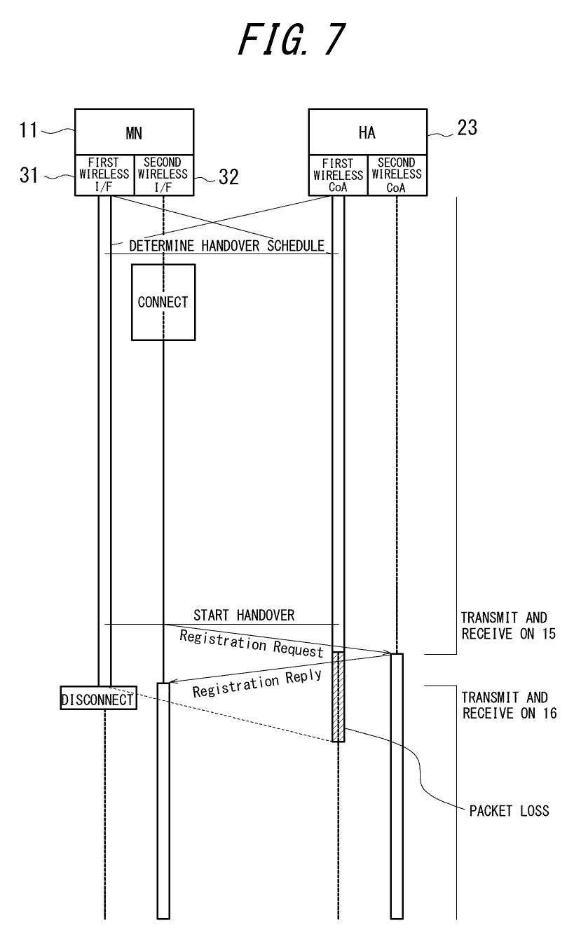

FIG. 7 is a sequence diagram illustrating the handover processing between the wireless communication apparatus 11 and the HA 23. A shown in FIG. 7, after determining the handover schedule, the handover control unit 36 of the wireless communication apparatus (MN) 11 controls the communication processing unit 34 to connect the second wireless I/F 32 to the second wireless communication network 16. Then, when the handover preparation time Ts has passed, the handover control unit 36 transmits Registration Request (Binding Update in NEMO), which is the handover request information, to the HA 23 via the second wireless communication network 16 of the handover destination. After transmitting the handover request information to the HA 23, the handover control unit 36 transmits a handover schedule notification, which indicates accordingly, as the handover information to the telephone function unit 33.

When receiving the handover request information, the HA 23 registers an IP address of the handover destination as a care-of address (second wireless CoA) and transmits Registration Reply (Binding Acknowledge in NEMO), which is the handover completion information, to the wireless communication apparatus 11 via the second wireless communication network 16. The HA 23 registers only a single care-of address for the wireless communication apparatus 11. Accordingly, the care-of address (second wireless CoA) of the handover destination is registered overwriting the care-of address (first wireless CoA) of the handover source already registered. From a point to register the care-of address of the handover destination, the HA 23 receives packets only from the care-of address (second wireless CoA) registered and does not accept the packets transmitted from the care-of address (first wireless CoA) previously registered.

Then, after receiving Registration Reply (Binding Acknowledge in NEMO), which is the handover completion information replied from the HA 23, the handover control unit 36 starts transmitting and receiving packets on the second wireless communication network 16 of the handover destination, as well as controlling the communication processing unit 34 so as to disconnect the first wireless I/F 31 from the first wireless communication network 15 of the handover source. After receiving the handover completion information from the HA 23, the handover control unit 36 transmits the handover completion notification, indicating accordingly, as the handover information to the telephone function unit 33.

As obvious from FIG. 7, after registering the IP address of the handover destination as the care-of address (second wireless CoA), the HA 23 does not accept packets transmitted from the handover source. Therefore, it results in losing packets arriving at the HA 23 after the handover request information reaches the HA 23, among the packets transmitted from the wireless communication apparatus 11 to the HA 23 via the first wireless communication network 15 of the handover source.

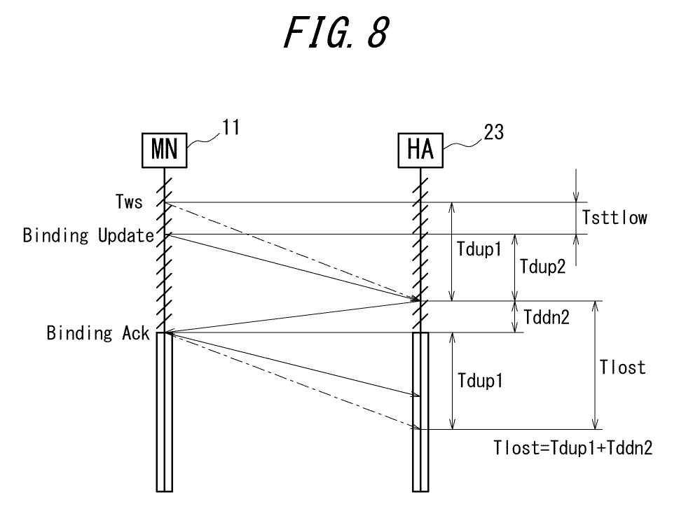

FIG. 8 is a diagram illustrating that packet loss occurs in this case. Here, NEMO is exemplified, for convenience. As shown in FIG. 8, after receiving Binding Update from the wireless communication apparatus (MN) 11 and registering the IP address of the handover destination as the care-of address (second wireless CoA), the HA 23 accepts packets only from the handover destination.

Therefore, if the uplink absolute delay time Tdup1 of the handover source is longer than the uplink absolute delay time Tdup2 of the handover destination, it results in losing the packets transmitted from the handover source from a point Tws, which is earlier by Tsttlow=Tdup1−Tdup2 from a point when the wireless communication apparatus (MN) 11 transmits Binding Update, to a point when the wireless communication apparatus (MN) 11 receives Binding Ack from the HA 23. A packet loss period Tlost is expressed as Tlost=Tdup1+Tddn2. In addition, the HA 23 does not receive packets after receiving Binding Update until packets from the handover destination arrive, that is, in a period of Tdup2+Tddn2. Chain lines shown in FIG. 8 indicate flows of the packets before handover.

Therefore, based on the handover information from the handover control unit 36, the telephone function unit 33 of the wireless communication apparatus 11 according to the present embodiment controls transmission of data such that transmission data expected to be lost by handover are accumulated in the transmission buffer 57 in the telephone function unit 33, and transmitted after completion of handover.

The following is a description of data transmission processing at handover by the telephone function unit 33.

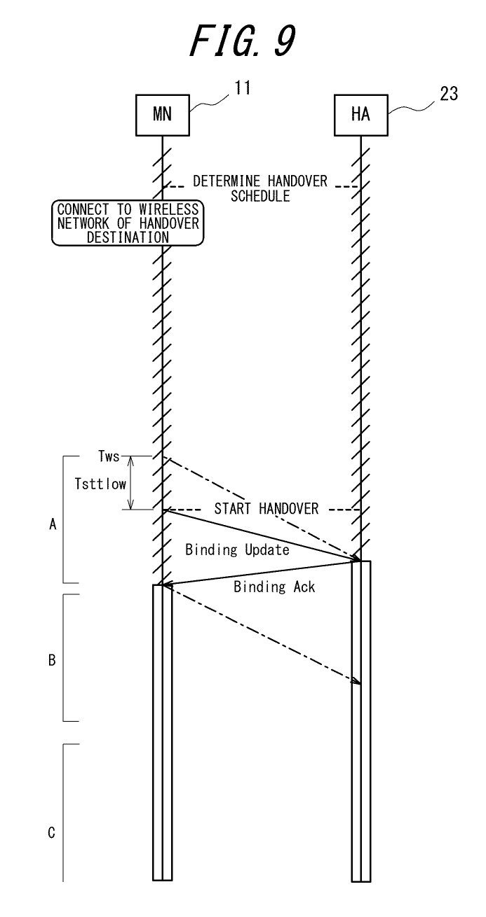

FIG. 9 is a diagram illustrating a summary of the data transmission processing at handover by the telephone function unit 33. As described above, the packets transmitted from the wireless communication apparatus (MN) 11 are lost in a period A, which corresponds to the packet loss period Tlost from the point Tws, which is at Tsttlow before the point when Binding Update is transmitted. Therefore, in the period A, the telephone function unit 33 lowers the encoding bit-rate of the transmission data and transmits the data while accumulating copies of the data in the transmission buffer 57.

Subsequently, the telephone function unit 33, after transmission of packets through the handover destination is started, transmits the data in the transmission buffer 57 at a rapid speed until there is no packet in the transmission buffer 57, while accumulating new data in the transmission buffer 57 (period B). Then, until end of the communication or start of the period A for a next handover schedule, the telephone function unit 33 encodes the transmission data with a normal encoding bit-rate and transmits the transmission data without accumulating them in the transmission buffer 57 (period C).

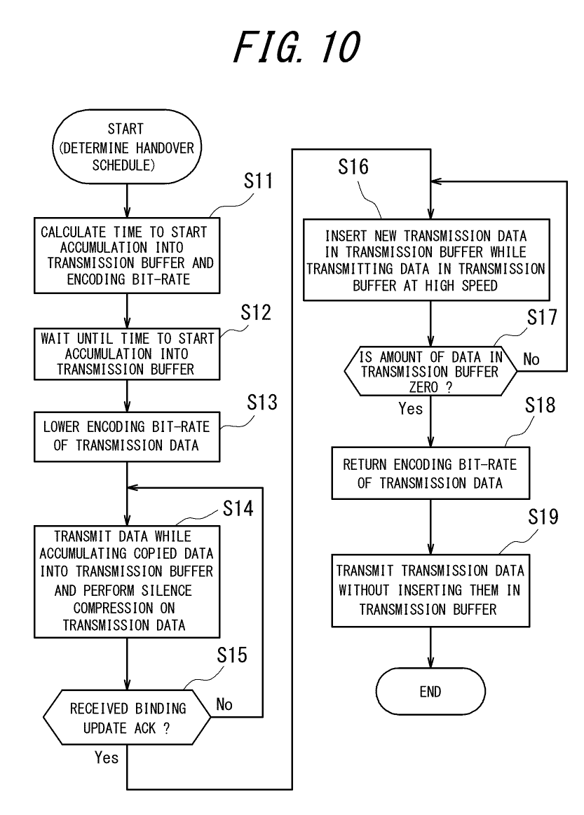

FIG. 10 is a flowchart illustrating operations of the transmission control unit 56 of the telephone function unit 33 at handover. The following is further detailed description of the data transmission processing of the telephone function unit 33 at handover, with reference to the flowchart shown in FIG. 10.

The handover information obtaining unit 55 of the telephone unit 33 monitors the handover information from the handover control unit 36 at predetermined intervals. If the handover schedule determination information is obtained as a result, the handover information obtaining unit 55 further obtains the handover preparation time Ts, the uplink absolute delay time Tdup1 of the handover source, the uplink and downlink absolute delay times Tdup2 and Tddn2 of the handover destination and the expected bandwidth Rbup2 of the handover destination from the handover control unit 36 as the required handover information, and provides such obtained information to the transmission control unit 56. Then, the handover information obtaining unit 55 monitors the handover schedule notification and the handover completion notification from the handover control unit 36 at predetermined intervals and provides such received information to the transmission control unit 56. If the handover completion notification is obtained, the handover information obtaining unit 55 returns to the process of obtaining information whether there is a handover schedule.

After obtaining the handover information from the handover information obtaining unit 55, the transmission control unit 56 transmits the handover information, except for the information on the expected bandwidth Rbup2 of the handover destination among the obtained information, to the communication apparatus 12. In addition, after obtaining the handover information, the transmission control unit 56 first calculates a time to start accumulating the data in the transmission buffer 57, which is the start time Tws of the period A in which packet loss occurs (see FIG. 8), and an encoding bit-rate R1 at that point (step 11).

Here, the data accumulation start time Tws is calculated by Tws=Ts−Tsttlow, where Tsttlow=Tdup1−Tdup2 calculated from Ts, Tdup1 and Tdup2 obtained. In addition, as the encoding bit-rate R1, the maximum value among obtainable encoding bit-rates is selected with a smaller one as an upper limit between (i) Sbf/Tlost and (ii) Rbup2/Vf, where Rbup2 (bps) represents the expected bandwidth obtained, Vf (sec/sec) represents the reproduction speed to the standard reproduction speed Vn of the communication apparatus 12 after handover, Sbf (bit) represents a maximum capacity of the transmission buffer 57, Tlost (sec) represents the packet loss period, and Rn (bps) represents the standard encoding bit-rate. Here, as the encoding bit-rate to be selected, it is also possible to select a lower encoding bit-rate, so as to have some margin in consideration of variation in the bandwidth. In addition, the reproduction speed Vf after handover is set in advance as 1.25 times of the standard reproduction speed Vn, for example, and may be stored in both of the communication apparatuses or the communication apparatus 12 may notify the wireless communication apparatus 11 in advance.

Then, the transmission control unit 56 waits until the packet accumulation start time Tws (step S12) and, if it reaches the packet accumulation start time Tws (start of the period A), instructs the encoder 44 to lower the encoding bit-rate of the transmission data to the encoding bit-rate R1 calculated (step S13). In addition, while providing the transmission data received from the encoder 44 to the packet transmission unit 45 as it stands, the transmission control unit 56 copies the transmission data and accumulates the copy in the transmission buffer 57 (step S14). At this time, a silent part longer than a predetermined length (for example, 500 msec) in the transmission data is compressed to the predetermined length.

The processing at step S14 is performed until the handover completion information from the HA 23 is received (step S15). Then, after receiving the handover completion information (Yes of S15, start of the period B), the transmission control unit 56 transmits the handover completion information to the communication apparatus 12 and, while accumulating the transmission data received from the encoder 44 in the transmission buffer 57 without providing the transmission data to the packet transmission unit 45, provides the data (packets) accumulated in the transmission buffer 57 at a fast speed to the packet transmission unit 45 in accordance with the bandwidth, from the oldest to the newest, so as to transmit the data to the communication apparatus 12 (step S16).

The transmission control unit 56 monitors the number of packets in the transmission buffer 57 (step S17). When the number of packets in the transmission buffer 57 becomes zero as a result (Yes of S17, start of a period C), the transmission control unit 56 instructs the encoder 44 to return the encoding bit-rate to an original thereof (step S18) and provides the packet transmission unit 45 with the transmission data from the encoder 44 without accumulating them in the transmission buffer 57 so as to transmit the transmission data to the communication apparatus 12 (step S19).

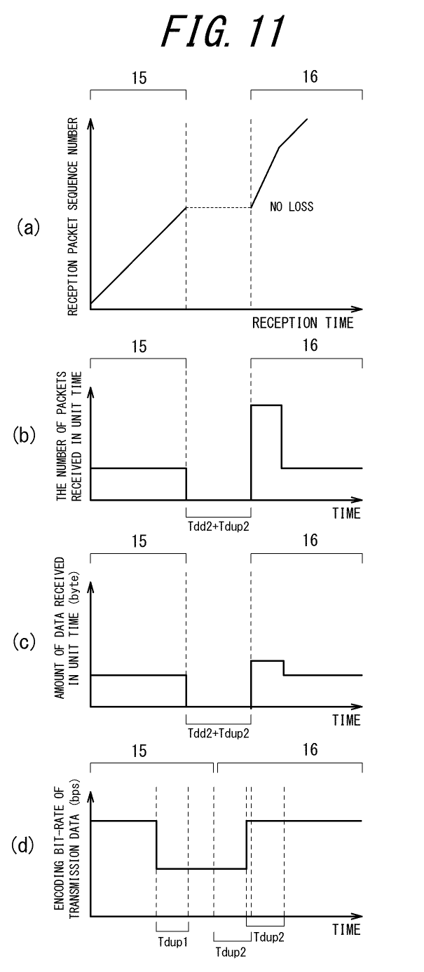

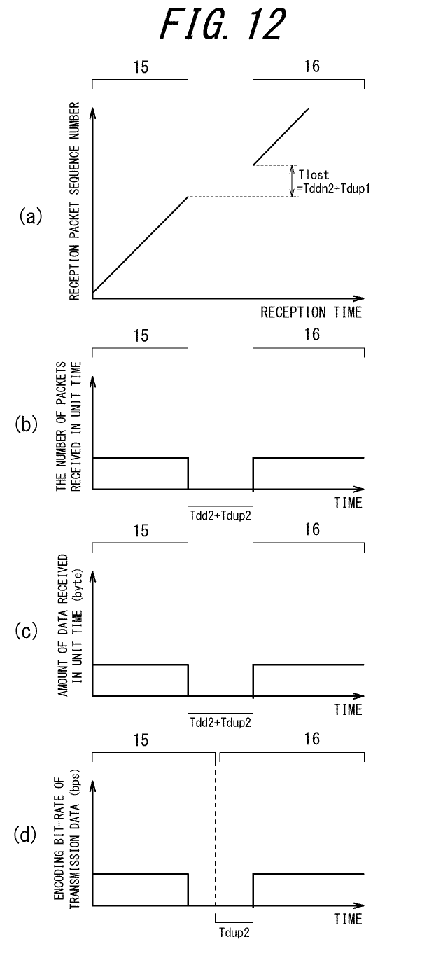

FIG. 11 is a diagram illustrating states of transmission and reception packets between the wireless communication apparatus 11 according to the present embodiment and the communication apparatus 12 when the wireless communication apparatus 11 performs transmission control at handover. FIG. 12 is a diagram, for comparison with FIG. 11, illustrating states of transmission and reception packets between the wireless communication apparatus 11 and the communication apparatus 12 when the wireless communication apparatus 11 does not perform the transmission control at handover. In FIG. 11 and FIG. 12, (a) shows a sequence number of reception packets of the communication apparatus 12; (b) shows the number of packets received in a unit time; (c) shows an amount of the data (byte) received in the unit time; and (d) shows the encoding bit-rate (bps) of the transmission data by the wireless communication apparatus 11.

As obvious from a comparison between FIG. 11 and FIG. 12, since the wireless communication apparatus (MN) 11 according to the present embodiment accumulates the transmission packets expected to be lost at handover in the wireless communication apparatus 11 itself and transmits such accumulated packets after handover, packet loss which occurred in FIG. 12(a) does not occur in FIG. 11(a). Accordingly, the communication apparatus (CN) 12 can maintain continuity of a sentence even at handover, and thus the user listening to voice will feel no sense of discomfort.

In addition, the encoding bit-rate of the transmission data is constant in FIG. 12(d), whereas the wireless communication apparatus (MN) 11 according to the present invention lowers the encoding bit-rate during accumulation of the packets, as shown in FIG. 11(d). Therefore, it is possible to transmit accumulated packets more than usual, without causing congestion of the accumulated packets in a limited bandwidth. Accordingly, the communication apparatus (CN) 12 on a reception side may return to reproduction with an original absolute delay by reproducing the packets received more than usual, as shown in FIGS. 11(b) and (c), at the reproduction speed faster than usual. In addition, the wireless communication apparatus (MN) 11 can reduce overall amount of data by performing silence compression on the accumulated packets and thereby transmit the accumulated packets faster.

Next, the communication apparatus (CN) 12 shown in FIG. 1 is described.

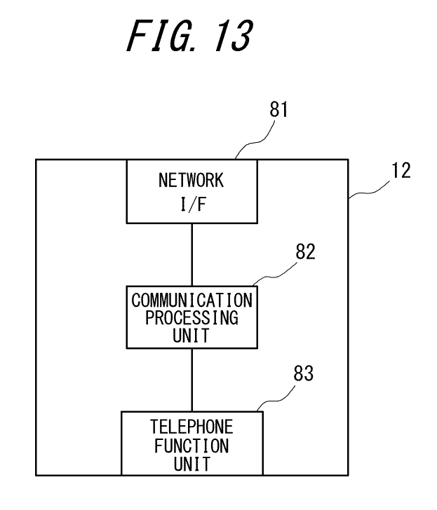

FIG. 13 is a functional block diagram illustrating a schematic constitution of the communication apparatus (CN) 12. The communication apparatus 12 includes a network I/F (interface) 81 for connecting to the internet 18 via an internet service provider (not shown), a communication processing unit 82 for controlling connection to the network, and a telephone function unit 83 for executing the VoIP application.

The communication processing unit 82 controls connection of the network I/F 81 to the internet 18 and performs communication between the telephone function unit 83 and the wireless communication apparatus 11.

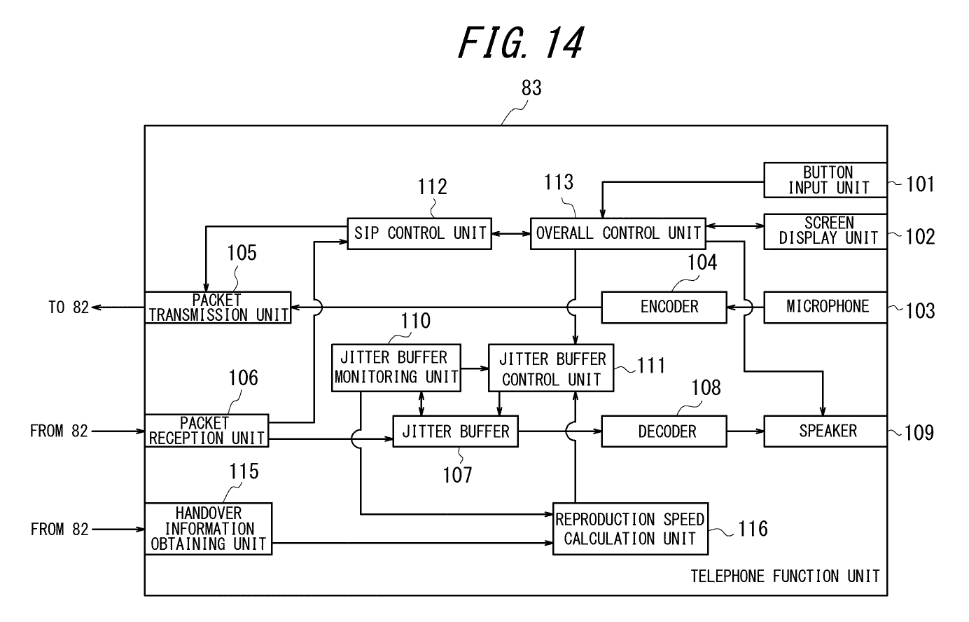

FIG. 14 is a functional block diagram illustrating a schematic constitution of the telephone function unit 83 of the communication apparatus 12 shown in FIG. 13. The telephone function unit 83 may be a softphone, for example, and, in the same manner as the configuration of a known softphone, includes a button input unit 101, a screen display unit 102, a microphone 103, an encoder 104, a packet transmission unit 105, a packet reception unit 106, a jitter buffer 107, a decoder 108, a speaker 109, a jitter buffer monitoring unit 110, a jitter buffer control unit 111, an SIP control unit 112, and an overall control unit 113 for controlling the overall operation. The microphone 103 and the speaker 109 may be designed as the handset 12a as shown in FIG. 1, for example.

The overall control unit 113 obtains operation information of the user via the button input unit 101 or the screen display unit 102 and controls the overall operation based on the operation information obtained. In addition, the SIP control unit 112 controls SIP procedure such as start or end of a call. During the call, voice data obtained by the microphone 103 are encoded by the encoder 104, and the data encoded are inserted into packets by the packet transmission unit 105 and then transmitted to the wireless communication apparatus 11 via the communication processing unit 82 and the network I/F 81.

In addition, the packets from the wireless communication apparatus 11, received by the packet reception unit 106 via the communication processing unit 82, are read out after once being stored in the jitter buffer 107. Payloads of the packets read out are decoded by the decoder 108 and output as reproduced voice from the speaker 109. Packet receiving states of the jitter buffer 107 and the number of packets (data amount) in the jitter buffer 107 are monitored by the jitter buffer monitoring unit 110. Based on a result of monitoring, the jitter buffer control unit 111 controls the reproduction speed of packets from the jitter buffer 107 and processing to discard the received packets.

The telephone function unit 83 of the communication apparatus 12 shown in FIG. 1 further includes a handover information obtaining unit 115 and a reproduction speed calculation unit 116. The handover information obtaining unit 115 monitors the handover information from the wireless communication apparatus 11, transferred from the HA 23, at predetermined intervals. If there is the handover schedule determination information as a result, the handover information obtaining unit 115 obtains required handover information from the wireless communication apparatus 11 and provides the required handover information to the reproduction speed calculation unit 116.

Based on the result of monitoring on the jitter buffer 107 by the jitter buffer monitoring unit 110 and the required handover information obtained from the handover information obtaining unit 115, the reproduction speed calculation unit 116 calculates a read-out speed of the packets in the jitter buffer 107, that is, the reproduction speed of the reception packets (here, reproduction speed of the VoIP application) and provides a result of such calculation to the jitter buffer control unit 111. Thereby, the jitter buffer control unit 111 controls reading out of the reception packets from the jitter buffer 107 such that the reproduction speed of the reception packets meets the reproduction speed calculated by the reproduction speed calculation unit 116.

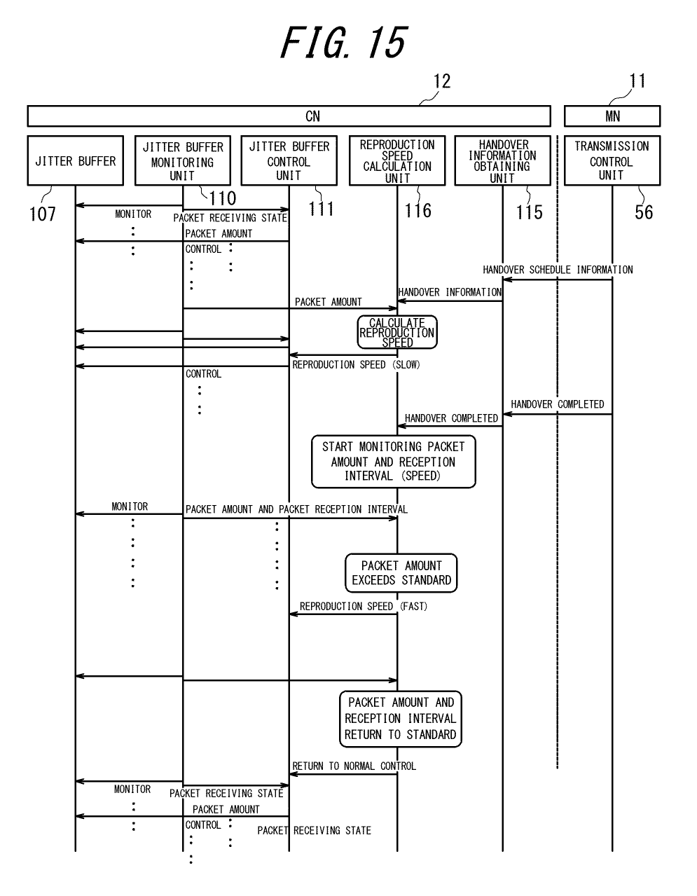

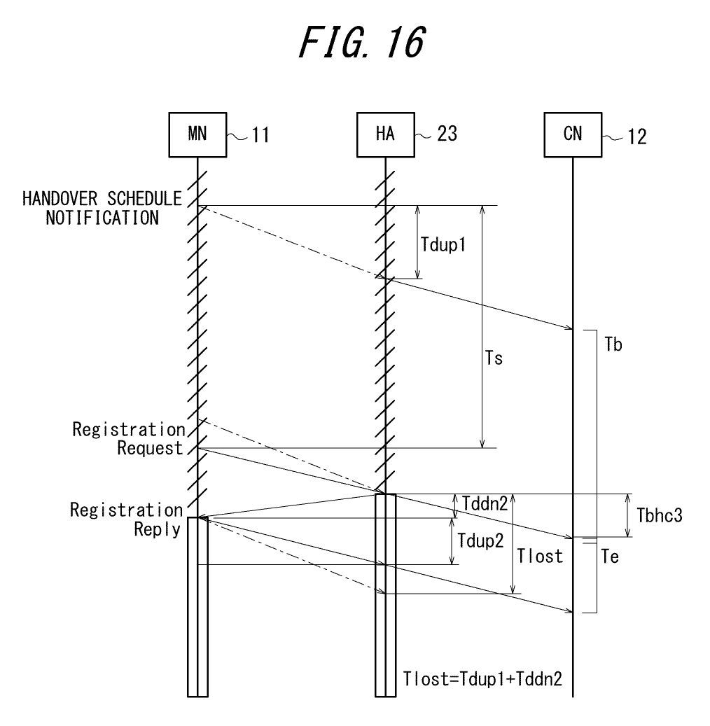

The following is a description of operations of the telephone function unit 83. FIG. 15 is a sequence diagram illustrating operations of a main section of the telephone function unit 83. FIG. 16 is a sequence diagram illustrating flow of the handover information among the wireless communication apparatus (MN) 11, the HA 23 and the communication apparatus (CN) 12. In FIG. 16, chain lines indicate flow of the packets from the wireless communication apparatus 11 to the HA 23 before handover.

The handover information obtaining unit 115 of the telephone function unit 83 monitors the handover information from the wireless communication apparatus 11 at predetermined intervals. If the handover schedule determination information is obtained as a result, the handover information obtaining unit 115 further obtains the handover preparation time Ts from the wireless communication apparatus 11, the uplink absolute delay time Tdup1 of the handover source, the uplink and downlink absolute delay times Tdup2 and Tddn2 of the handover destination and provides them to the reproduction speed calculation unit 116.

In addition, the reproduction speed calculation unit 116 obtains the current number of accumulated packets Tc (sec) in the jitter buffer 107 from the jitter buffer monitoring unit 110 as well as obtaining an absolute delay time Tdhc3 to the HA 23. The absolute delay time Tdhc3 to the HA 23 is ½ of a value of RTT (Round Trip Time) measured by transmitting and receiving packets to and from the HA 23.

Then, based on such information obtained, the reproduction speed calculation unit 116 calculates the reproduction speed Vs (sec/sec) before handover completion, that is, a time ratio to the standard reproduction speed Vn, by using the following formula.

Vs=(Tb+Tc)/(Tb+Ta) [Formula 4]

Here, Tb is a period (sec) before handover and obtained by Tb=Ts−Tdup1−Tdhc3, as shown in FIG. 16. In addition, Ta is a period in which the packets do not arrive because of handover and obtained by Ta=Tdup2+Tddn2. That is, a reproduction speed is calculated as the reproduction speed Vs here such that no undesired silence occurs in reproduction, and that the number of packets in the jitter buffer 107 becomes zero at a point when the packets arrive from the handover destination.

The reproduction speed Vs calculated by the reproduction speed calculation unit 116 is provided to the jitter buffer control unit 111. Thereby, the jitter buffer control unit 111 controls reading out of the reception packets from the jitter buffer 47 so as to reproduce the reception packets at the calculated reproduction speed Vs, which is slower than the standard reproduction speed Vn.

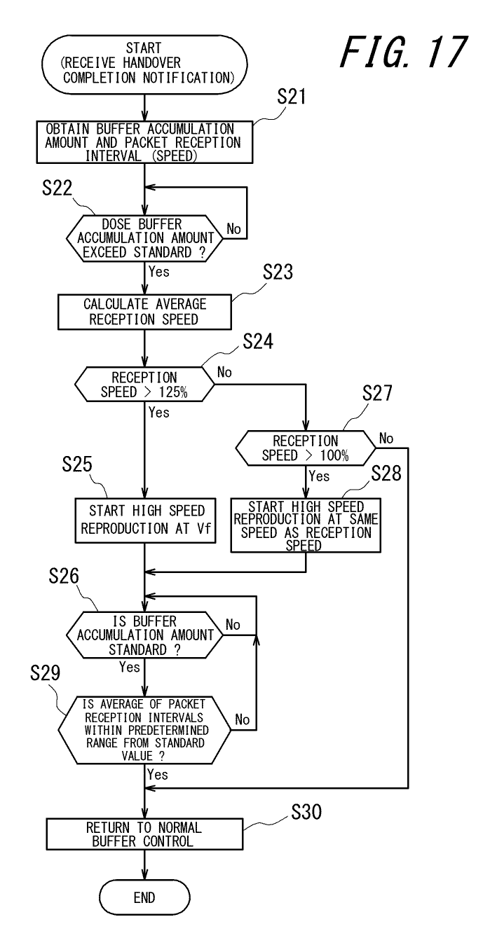

Then, after obtaining the handover completion information from the handover information obtaining unit 115, the reproduction speed calculation unit 116 controls reading out of the reception packets from the jitter buffer 107 via the jitter buffer control unit 111, in accordance with a flowchart shown in FIG. 17.

The following is a description on a control to read out the packets from the jitter buffer 107 after handover is completed, with reference to the flowchart shown in FIG. 17. First, after receiving the handover completion information, the reproduction speed calculation unit 116 obtains the number of packets accumulated (packet number) in the jitter buffer 107 and packet reception intervals (reception speed) periodically (step S21) and monitors whether the amount of accumulated packets in the jitter buffer 107 exceeds a standard accumulated amount (step S22). If the amount exceeds the standard accumulated amount (Yes of S22) as a result, the reproduction speed control unit 116 calculates an average reception speed with the reception speeds in a past predetermined period (step S23) and determines whether the calculated reception speed exceeds 125% of the standard speed, which corresponds to the reproduction speed Vf (1.25) set in advance (step S24).

Here, if the reception speed exceeds 125% of the standard speed (Yes of S24), the reproduction speed calculation unit 116 instructs the jitter buffer control unit 111 to start a fast reproduction at the reproduction speed Vf (step S25) and monitors whether the amount of accumulated packets in the jitter buffer 107 becomes the standard (step S26).

In contrast, at step S24, if the average reception speed does not exceed 125% of the standard speed (No of S24), the reproduction speed calculation unit 116 determines whether the average reception speed is the standard speed (100%) (step S27). If the average reception speed exceeds the standard (Yes of S27) as a result, the reproduction speed calculation unit 116 instructs the jitter buffer control unit 111 to start the rapid reproduction at the same speed as the average reception speed calculated at step S23 (step S28) and then shifts to step S26.

After that, the reproduction speed calculation unit 116 still continues to periodically monitor the accumulated amount in the jitter buffer 107 and the packet reception intervals (reception speed). Then, at step S26, when the amount of the accumulated packets in the jitter buffer 107 becomes the standard (Yes of S26), the reproduction speed calculation unit 116 determines whether an average of the packet reception intervals (reception speed) is within a predetermined range from a standard value (step S29). If the amount of the accumulated packets becomes the standard and the packet reception intervals is within the predetermined range (Yes of S29) as a result, the reproduction speed calculation unit 116 instructs the jitter buffer control unit 111 to return to normal control of the jitter buffer 107 (step S30) and ends control at handover. If the average reception speed calculated at step S23 does not exceed the standard speed at step S27 (No of S27), the reproduction speed calculation unit 116 shifts to step S30 to return to the normal control of the jitter buffer 107 in the similar manner as described above.

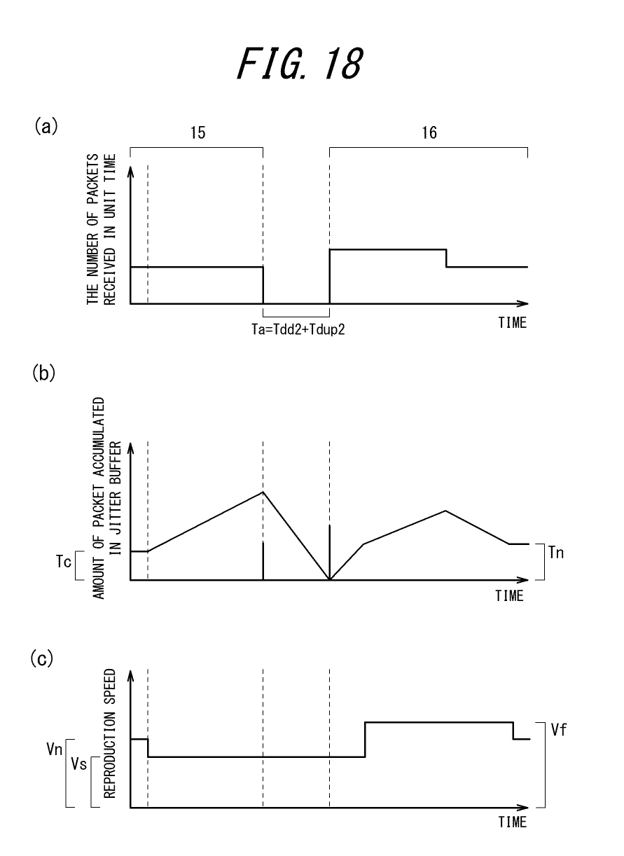

FIG. 18 is a diagram illustrating the reproduction control of the packets by the communication apparatus 12 described above. FIG. 18(a) shows the number of packets received by the jitter buffer 107 in a unit time; FIG. 18(b) shows the amount of accumulated packets in the jitter buffer 107; and FIG. 18(c) shows the reproduction speed. Here, FIG. 18(a) shows an exemplary case in which the jitter buffer 107 receives the number of packets more than 125% of the standard number of reception packets in a first part of handover to the second wireless communication network 16, and then receives the number of packets equals to the standard amount of reception packets. In FIG. 18(b), an accumulated packet amount Tn represents the standard accumulated amount corresponding to the standard reproduction speed Vn.

As obvious from FIG. 18, based on the handover information including the handover schedule notification, the communication apparatus 12 reduces the reproduction speed of the application from the standard reproduction speed Vn to the reproduction speed Vs, which is a constant speed at which the number of packets in the jitter buffer 107 becomes zero at a point to start receiving packets from the handover destination. Then, after confirming that handover is completed and the amount of accumulated packets in the jitter buffer 107 and the packet reception intervals return to standard, the communication apparatus 12 returns the reproduction speed to the standard reproduction speed Vn.

Accordingly, it is possible to reproduce the application at the constant reproduction speed closer to the standard reproduction speed even in the period (Ta=Tdup2+Tddn2) in which packets do not arrive because of handover, which prevents deterioration of reproduction quality and real-time property.

The jitter buffer control unit 111 executes control to reproduce the packets at the reproduction speed Vs, which is slower than the standard reproduction speed Vn, by one of the first and the second reproduction speed control methods described below, for example.

(a) First Reproduction Speed Control Method

It is assumed that TR=TR1/k, where TR1 represents a read-out interval of the packets from the jitter buffer 107 corresponding to the standard reproduction speed Vn, k is (Tb+Tc)/(Tb+Ta), and TR represents a read-out interval of the packets from the jitter buffer 107 corresponding to the calculated reproduction speed Vs. For example, in order to render the reproduction speed Vs to be 80% (k=0.8) of the standard reproduction speed Vn for the VoIP application which reads out and reproduces the packets in the jitter buffer 107 at intervals of 20 msec at the standard reproduction speed Vn, the interval TR to read out the packets from the jitter buffer 47 is calculated as TR=20/0.8 (msec).

(b) Second Reproduction Speed Control Method

When control of the reproduction speed for handover is started, a time stamp of a packet reproduced immediately thereafter and a reproduction time thereof are recorded in combination. Packets thereafter are read out from the jitter buffer 107 and reproduced at a time Tv shown in the following formula. In the following formula, TD represents the delay time and an initial value thereof is zero.

Tv=(time stamp of packet−time stamp of first packet)+(reproduction time of first packet+TD) [Formula 5]

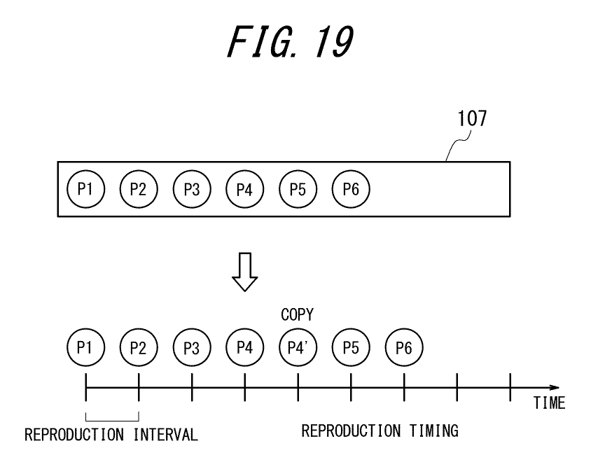

Here, when the packets are read out from the jitter buffer 107, a packet read out at [{Vn/(Vn−Vs)}−1]th is copied and stored in a memory in the decoder 108. After reproduction of the original packet, the copied packet is read out and reproduced at next reproduction timing. For example, in order to render the reproduction speed Vs to be 80% of the standard reproduction speed Vn, four sequential packets P1 to P4 in the jitter buffer 107 are read out and reproduced sequentially and the fourth packet P4 is copied, and a copied packet P4′ is reproduced at a next reproduction timing after reproduction of the original packet P4, as shown in FIG. 19. Then, when a packet P5 is read out from the jitter buffer 107, the TD is increased as long as the time of reproduction intervals by copying. It is to be noted that, if the packet to be read out at [{Vn/(Vn−Vs}−1]th is not in the jitter buffer 107 because of not being received yet or being discarded, the same processing is performed on a packet of a next reproduction timing.

With the processing described above, the communication apparatus 12 can appropriately respond to a state, in which there is the period that no packets arrive at handover of the wireless communication apparatus 11 and then the accumulated packets arrive rapidly, and reproduce the packets at an optimum speed.

Although the packets are transmitted from the wireless communication apparatus 11 to the communication apparatus 12 via the HA 23 by using Reverse Tunneling of a mobile IP or NEMO in the above first embodiment, loss of the transmission packets from the wireless communication apparatus 11 to the communication apparatus 12 because of handover is also caused by a difference in the delay times of route at handover when the route optimization is performed in mobile IPv6 and the wireless communication apparatus 11 and the communication apparatus 12 directly transmit and receive the packets with each other. Accordingly, in such a case as well, it is possible to prevent packet loss by accumulating the packets to be transmitted from the wireless communication apparatus 11 at handover and transmitting such accumulated packets after handover, in a similar manner to the above embodiment.

In addition, although handover is performed to the second wireless communication network 16 with the uplink absolute delay time shorter than that of the first wireless communication network 15 in the above embodiment, it is also possible to prevent packet loss in a similar manner when handover is performed from the second wireless communication network 16 to the first wireless communication network 16 with a long uplink absolute delay time. In this case, packets transmitted from the handover source are lost from a start point at Tsttlow=Tdup1−Tdup2 before a point when the wireless communication apparatus (MN) 11 transmits the handover request information such as Binding Update and the like, to a point when the wireless communication apparatus (MN) 11 receives the handover completion information such as Binding Ack and the like from the HA 23. Therefore, the packet loss period Tlost is Tlost=Tdup1+Tddn2 in this case, and the transmission packets in this period are accumulated in the transmission buffer 57 and transmitted at a rapid speed after handover is completed. A period in which the HA 23 does not receive packets from the wireless communication apparatus 11 because of handover is Tdup2+Tddn2, in this case.

Moreover, although the reproduction speed calculation unit 116 of the communication apparatus 12 described above calculates the reproduction speed Vs such that the number of packets in the jitter buffer 107 is zero at the point to start receiving packets from the handover destination, it is also possible to calculate the reproduction speed Vs such that the number of packets in the jitter buffer 107 becomes a predetermined number at the point to start receiving the packets from the handover destination.

### Second Embodiment

Next, a communication apparatus according to a second embodiment of the present invention is described.

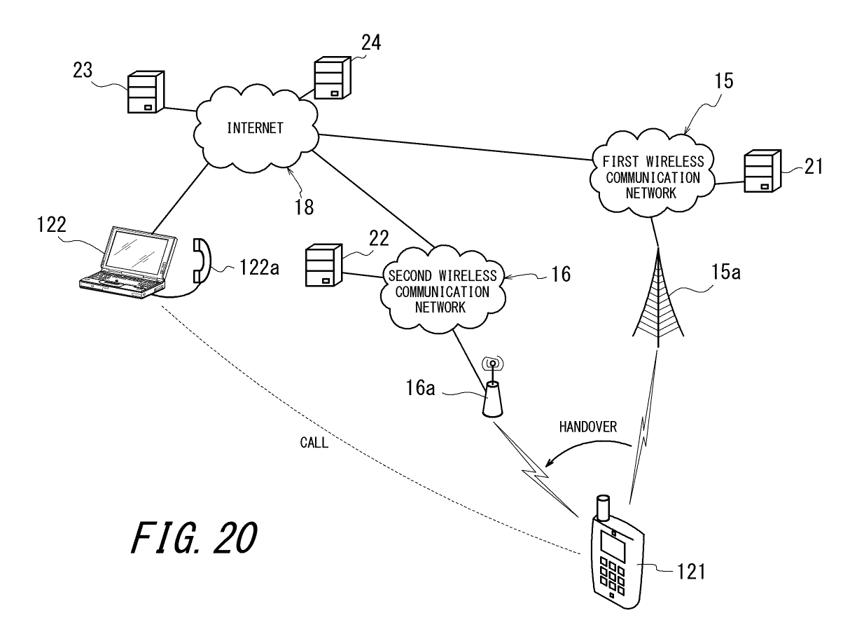

FIG. 20 is a diagram illustrating a schematic constitution of a communication network which the communication apparatus according to the second embodiment of the present invention can use. The communication network shown in FIG. 20 has the same constitution as that shown in FIG. 1. It is assumed that a wireless communication apparatus (MN) 121 as a mobile node can perform handover between the first wireless communication network 15 and the second wireless communication network 16 and calls a communication apparatus (CN) 122 as a correspondent node by using VoIP which is an application for real-time communication. In the communication network shown in FIG. 20, same reference signs are used to identify the elements which operate similarly to those of the communication network shown in FIG. 1 and descriptions thereof are omitted.

The communication terminal 122 may be a personal computer, for example, having a handset 122a connected thereto and a softphone installed therein, and is connected to the internet 18, which is a communication network, via an internet service provider (not shown).

In FIG. 20, it is assumed that the wireless communication apparatus 121 performs handover to the second wireless communication network, in a state that the wireless communication apparatus 121 registers an IP address of the first wireless communication network 15 as a care-of address (first wireless CoA) to the HA 23 and communicates with the communication apparatus 122 via the first wireless communication network 15.

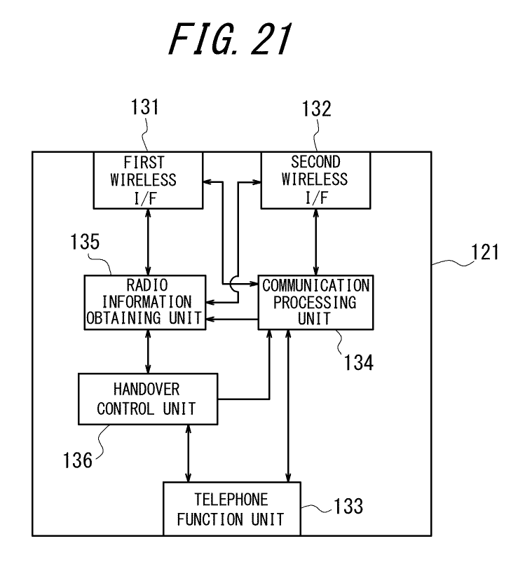

FIG. 21 is a functional block diagram illustrating a schematic constitution of the wireless communication apparatus 121 shown in FIG. 20. Similarly to the wireless communication apparatus 11 shown in FIG. 2, the wireless communication apparatus 121 includes a first wireless I/F (interface) 131 corresponding to the first wireless communication network 15, a second wireless I/F 132 corresponding to the second wireless communication network 16, a telephone function unit 133 for executing the VoIP application, a communication processing unit 134 for controlling connection to the first wireless communication network 15 and the second wireless communication network 16, a radio information obtaining unit 135 for obtaining radio information of the first wireless communication network 15 and the second wireless communication network 16, and a handover control unit 136 for controlling handover between the first wireless communication network 15 and the second wireless communication network 16.

In a similar manner as the communication processing unit 34 shown in FIG. 2, the communication processing unit 134 controls connection of the first wireless I/F 131 or the second wireless I/F 132 such that the telephone function unit 133 and the communication apparatus 122 communicates via the first wireless communication network 15 or the second wireless communication network 16 and communicate with the HA 23 under control of the handover control unit 136.

In a similar manner as the radio information obtaining unit 35 shown in FIG. 2, the radio information obtaining unit 136 obtains communication quality (for example, RSSI) of the first wireless communication network 15 and the second wireless communication network 16 as radio information from the first wireless I/F 131 and the second wireless I/F 132, correspondingly, and provides the communication quality obtained to the handover control unit 136.

The handover control unit 136 generates handover information including a determination whether to schedule handover, that is, whether to start handover preparation, based on the communication quality provided from the radio information obtaining unit 135, and then controls handover based on the handover information.

The following is a further detailed description of operations of the handover control unit 136.

In a similar manner as the handover control unit 36 shown in FIG. 2, for example, the handover control unit 136 determines the handover schedule based on the communication quality obtained from the first wireless I/F 131 and the second wireless I/F 132 via the radio information obtaining unit 135.

After determining the handover schedule, the handover control unit 136 obtains the handover preparation time Ts (sec), which is the time before transmitting Registration Request (Binding Update in NEMO) as the handover request information, the uplink absolute delay time Tdup1 (sec) and the downlink absolute delay time Tddn1 (sec) of the wireless communication network currently being used (here, the first wireless communication network 15) between the wireless communication apparatus 121 and the HA 23, the uplink absolute delay time Tdup2 (sec) and the downlink absolute delay time Tddn2 (sec) of the wireless communication network of the handover destination (here, the second wireless communication network 16) between the wireless communication apparatus 121 and the HA 23, and an expected bandwidth Rbdn2 (bps) of the downlink of the wireless communication network of the handover destination at completion of handover of HA 23, that is, at a point when the handover request information arrives at the HA 23.

Then, the handover control unit 136 provides such obtained information as the required handover information to the telephone function unit 133, including the handover schedule determination information indicating determination on the handover schedule. The telephone function unit 133 selectively transmits the handover information obtained from the handover control unit 136 as the handover notification message to the communication apparatus 12 via the HA 23, in accordance with a result of comparison of the absolute delay times described below.

The handover control unit 36 obtains the handover preparation time Ts, the uplink and downlink absolute delay times Tdup1 and Tddn1 of the handover source, the uplink and downlink absolute delay times Tdup2 and Tddn2 of the handover destination, and the expected bandwidth Rbdn2 of the handover destination by the obtaining methods described in the first embodiment, for example.

That is, the handover preparation time Ts is obtained by the method described with reference to FIGS. 4(a) and (b). In addition, the absolute delay times Tdup1, Tddn1, Tdup2 and Tddn2 are obtained by any one of the first to third methods to obtain absolute delay time and stored in a memory (not shown) in the handover control unit 136 for each wireless communication network.

For example, by the first method to obtain absolute delay time, the absolute delay times Tdup1, Tddn1, Tdup2 and Tddn2 of corresponding network are measured by using the reception times of the measuring packets from the HA 23 via the first wireless I/F 131 and the second wireless IT 132 and the time stamps of the measuring packets.

By the second method to obtain absolute delay time, the absolute delay times Tdup1, Tddn1, Tdup2 and Tddn2 are measured by using the transmission times of the measuring packets, such as PING, RTCP and the like, to the HA 23 through the first wireless communication network 15 and the second wireless communication network 16 and reception times of the replies.

By the third method to obtain the absolute delay time, the absolute delay times Tdup1, Tdup2 and Tddn2 are obtained by Formula 2 and Formula 3 shown above, and the absolute delay time Tddn1 is obtained by the following formula.

Tddn1=Tn3+Trdn3=Tn1+Trdn1+(Tn3−Tn1) [Formula 6]

In addition, the expected bandwidth Rbdn2 of the downlink of the handover destination is obtained by expecting the radio state of the downlink in the wireless communication network of the handover destination when the HA 23 completes handover. Therefore, a conversion table of the radio state (communication quality) and throughput (expected bandwidth) as shown in FIG. 6, for example, is stored in the handover control unit 136 in advance. The handover control unit 136 linearly expects the radio state of the handover destination at completion of handover based on the radio state of the handover destination at the point when the handover schedule is determined and the radio state of the handover destination at a predetermined time before the point, for example, and obtains the expected bandwidth Rbdn2 of the handover destination at completion of the handover from the conversion table shown in FIG. 6 based on the radio state expected. Here, the point of handover completion is a point at a sum of the handover preparation time Ts and the uplink absolute delay time Trup2 of the wireless communication network of the handover destination (here, the second wireless communication network 16) between the HA 23 and the wireless communication apparatus 11 after the point to determine the handover schedule.

As set forth above, the handover control unit 136 obtains the handover preparation time Ts, the uplink and downlink absolute delay times Tdup1 and Tddn1 of the handover source, the uplink and downlink absolute delay times Tdup2 and Tddn2 of the handover destination, and the expected bandwidth Rbdn2 of the downlink of the handover destination, and provides such obtained information as the required handover information, together with the handover schedule determination information indicating determination on the handover schedule, to the telephone function unit 133.

In addition, if the handover schedule is determined, the handover control unit 136 performs handover processing.

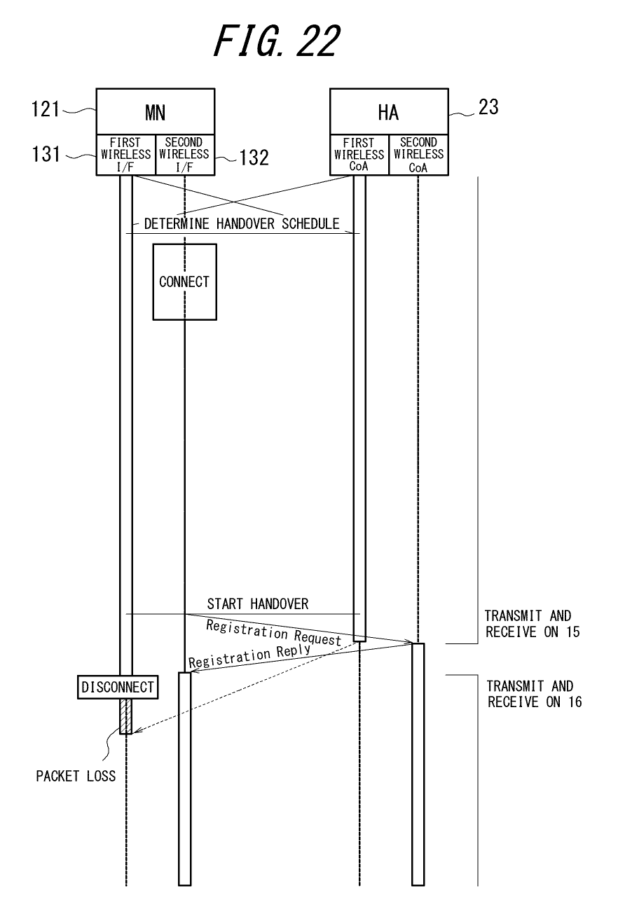

FIG. 22 is a sequence diagram illustrating a handover processing between the wireless communication apparatus 121 and the HA 23. A shown in FIG. 22, after determining the handover schedule, the handover control unit 136 of the wireless communication apparatus (MN) 121 controls the communication processing unit 134 to connect the second wireless I/F 132 to the second wireless communication network 16. Then, when the handover preparation time Ts has passed, the handover control unit 136 transmits Registration Request (Binding Update in NEMO), which is handover request information, to the HA 23 via the second wireless communication network 16 of the handover destination.

After receiving the handover request information, the HA 23 registers an IP address of the handover destination as the care-of address (second wireless CoA) and transmits Registration Reply (Binding Acknowledge in NEMO), which is the handover completion information, to the wireless communication apparatus 121 via the second wireless communication network 16. The HA 23 registers only one care-of address for the wireless communication apparatus 121. Accordingly, the care-of address of the handover destination (second wireless CoA) is registered overwriting the care-of address (first wireless CoA) of the handover source already registered.

Then, after receiving Registration Reply (Binding Acknowledge in NEMO), which is the handover completion information replied from the HA 23, the handover control unit 136 starts transmitting and receiving packets through the second wireless communication network 16 of the handover destination, as well as controlling the communication processing unit 134 so as to disconnect the first wireless I/F 131 from the first wireless communication network 15 of the handover source. After receiving the handover completion information from the HA 23, the handover control unit 136 transmits the handover completion notification, indicating accordingly, as the handover information to the telephone function unit 133.

As obvious from FIG. 22, if the downlink absolute delay time Tddn1 via the first wireless communication network 15 of the handover source is longer than the downlink absolute delay time Tddn2 via the second wireless communication network 16 of the handover destination, packet loss occurs as the wireless communication apparatus (MN) 121 cannot receive packets which has been transmitted to the first wireless communication network 15 of the handover source after disconnecting the first wireless I/F 131 from the first wireless communication network 15 of the handover source.

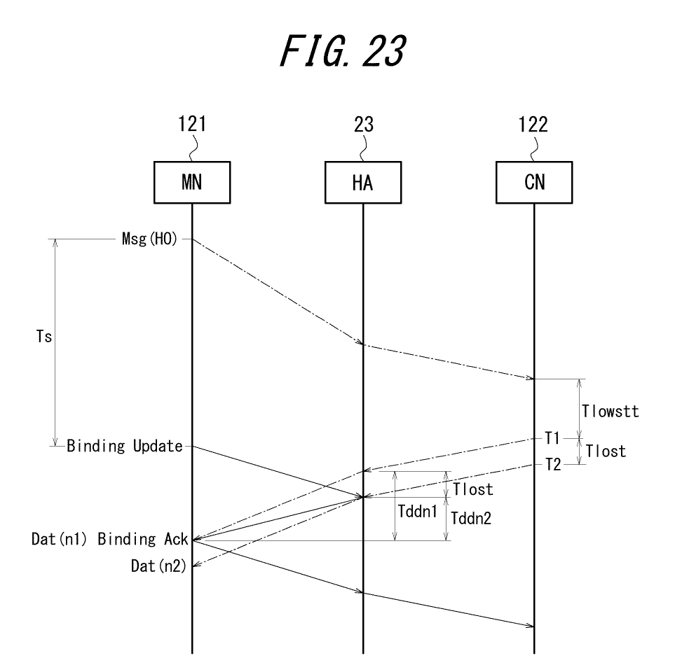

FIG. 23 is a diagram illustrating occurrence of packet loss in this case. Here, NEMO is exemplified for convenience. As shown in FIG. 23, after receiving Binding Ack from the HA 23, the wireless communication apparatus (MN) 121 receives the packets only from the handover destination. Therefore, if the downlink absolute delay time Tddn1 of the handover source is longer than the downlink absolute delay time Tddn2 of the handover destination, the wireless communication apparatus (MN) 121 cannot receive the packets transmitted from the first wireless communication network 15 of the handover source in a period from when the wireless communication apparatus (MN) 121 receives Binding Ack to a point (Tddn1−Tddn2) thereafter. This period (Tddn1−Tddn2) is the packet loss period Tlost.

Here, provided that T1 represents a transmission timing of data Dat (n1) transmitted first by the communication apparatus (CN) 122 in the packet loss period Tlost and T2 represents a transmission timing of data Dat(n2) transmitted last by the communication apparatus (CN) 122 in the packet loss period Tlost, a period Tlowstt(sec), from when the communication apparatus (CN) 122 receives the handover notification message Msg(HO) from the wireless communication apparatus (MN) 121 via the HA 23 to the transmission timing T1 of the data Dat(n1), is obtained as follows by using the handover information included in the handover notification message Msg(HO) and the absolute delay time Tdn between the communication apparatus (CN) 122 and the HA 23. The absolute delay time Tdn between the communication apparatus (CN) 122 and the HA 23 may be obtained by transmitting and receiving the packets therebetween and measuring RTT (Round Trip Time) and then dividing a calculated value by 2.

$$\begin{matrix}Tlowstt = Ts - Tdup 1 - Tdn + Tdup 2 - Tdn - \\ ( Tddn 1 - Tddn 2 ) \\ = Ts + Tddn 2 - 2 Tdn - ( Tddn 1 + Tdup 1 ) + \\ Tdup 2\end{matrix} \qquad [ Formula 7 ]$$

After obtaining the handover information from the handover control unit 136, the telephone function unit 133 compares the downlink absolute delay time Tddn1 of the handover source and the downlink absolute delay time Tddn2 of the handover destination. If Tddn1>Tddn2 is satisfied, the telephone function unit 133 transmits all of the handover information obtained as the handover notification message to the communication apparatus (CN) 122 via the HA 23. Thereby, based on the handover information from the wireless communication apparatus (MN) 121 and the absolute delay time Tdn described above between the communication apparatus (CN) 122 and the HA 23, the communication apparatus (CN) 122 accumulates the transmission data expected to be lost because of handover in the communication apparatus (CN) 122 itself and controls transmission of the data such that the wireless communication apparatus 121 can receive the data after handover is completed. It is to be noted that the absolute delay time Tdn between the communication apparatus (CN) 122 and the HA 23 may be measured and stored in the communication apparatus (CN) 122 in advance, or measured by receiving the handover information from the wireless communication apparatus (MN) 121.

The following is a constitution and operations of the communication apparatus (CN) 122 according to the present embodiment shown in FIG. 20.

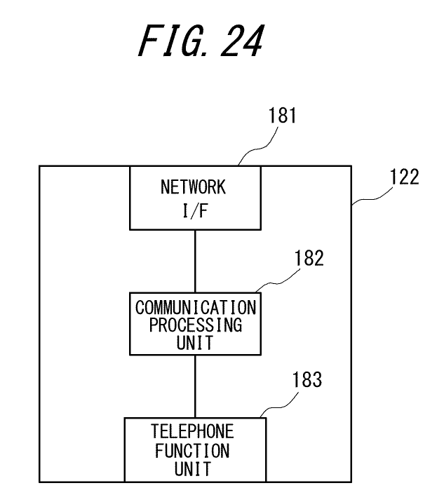

FIG. 24 is a functional block diagram illustrating a schematic constitution of the communication apparatus (CN) 122. The communication apparatus 122 includes a network I/F (interface) 181 for connecting to the internet 18 via the internet service provider (not shown), a communication processing unit 182 for controlling connection to the network, and a telephone function unit 183 for executing the VoIP application.

The communication processing unit 182 controls connection of the network I/F 181 to the internet 18 to perform communication between the telephone function unit 183 and the wireless communication apparatus 121. Accordingly, the network I/F 181 and the communication processing unit 182 constitute a communication unit.

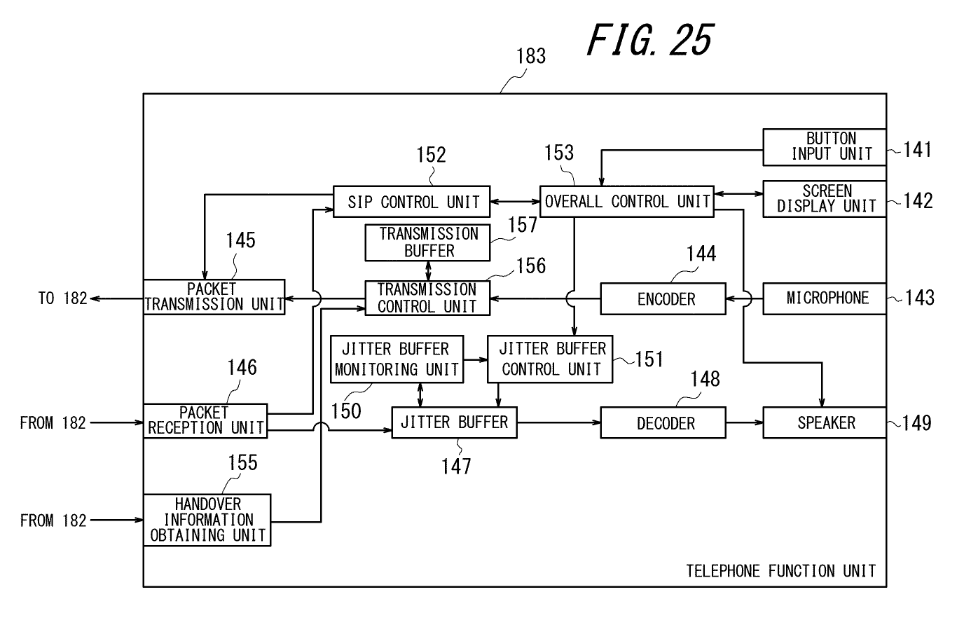

FIG. 25 is a functional block diagram illustrating a schematic constitution of the telephone function unit 183 of the communication apparatus 122 shown in FIG. 24. The telephone function unit 183 may be a softphone, for example, and in the same manner as the communication apparatus 12 shown in FIG. 14, has a configuration of a known softphone, and includes a button input unit 141, a screen display unit 142, a microphone 143, an encoder 144, a packet transmission unit 145, a packet reception unit 146, a jitter buffer 147, a decoder 148, a speaker 149, a jitter buffer monitoring unit 150, a jitter buffer control unit 151, an SIP control unit 152, and an overall control unit 153 for controlling the overall operation. The microphone 143 and the speaker 149 may be designed as the handset 122a as shown in FIG. 20, for example.

The overall control unit 153 obtains operation information of the user via the button input unit 141 or the screen display unit 142 and controls the overall operation based on the information obtained. In addition, the SIP control unit 152 controls SIP procedure such as start or end of a call. During the call, voice data obtained by the microphone 143 are encoded by the encoder 144, and the data encoded are inserted into packets by the packet transmission unit 145 and then transmitted to the wireless communication apparatus 121 via the communication processing unit 182 and the network I/F 181.

In addition, the packets from the wireless communication apparatus 121, received by the packet reception unit 146 via the communication processing unit 182, are read out after once stored in the jitter buffer 147. Payloads of the packets read out are decoded by the decoder 148 and output as reproduced voice from the speaker 149. Packet receiving states of the jitter buffer 147 and the number of packets (data amount) in the jitter buffer 147 are monitored by the jitter buffer monitoring unit 150. Based on a result of monitoring, the jitter buffer control unit 151 controls the read-out speed of the packets from the jitter buffer 147 and processing to discard the received packets.

The telephone function unit 183 of the communication apparatus 122 shown in FIG. 20 further includes a handover information obtaining unit 155, a transmission control unit 156 and a transmission buffer 157. That is, the telephone function unit 183 has the same configuration as the telephone function unit 33 of the wireless communication apparatus 11 according to the first embodiment shown in FIG. 3.

The handover information obtaining unit 155 monitors the handover notification message from the wireless communication apparatus 121 at predetermined intervals so as to obtain the handover schedule determination information to determine the handover schedule. Then, if the handover schedule determination information is obtained, the handover information obtaining unit 155 further obtains the required handover information from the wireless communication apparatus 121 and provides the required handover information to the transmission control unit 156.

The transmission control unit 156 controls encoding bit-rate of transmission data by the encoder 144 and transmission of data from the encoder 144 to the packet transmission unit 145. That is, the transmission control unit 156 transmits the data encoded by the encoder 144 directly to the packet transmission unit 145 in a normal call state in which the handover information is not provided from the handover information obtaining unit 155. In contrast, if the handover information is provided from the handover information obtaining unit 155, the transmission control unit 156 obtains the absolute delay time Tdn described above and, based on the absolute delay time Tdn and the handover information, controls so as to accumulate the data from the encoder 144 expected to be lost by handover in the transmission buffer 157 and to transmit such accumulated data to the packet transmission unit 145 after handover is completed. Transmission control by the transmission control unit 156 will be further described below.

Accordingly, the telephone function unit 183 of the wireless communication apparatus 122 according to the present embodiment constitutes an execution unit for executing the application for the real-time communication and a control unit for controlling transmission of the data by the application.

Next, data transmission processing by the telephone function unit 183 at handover is described.

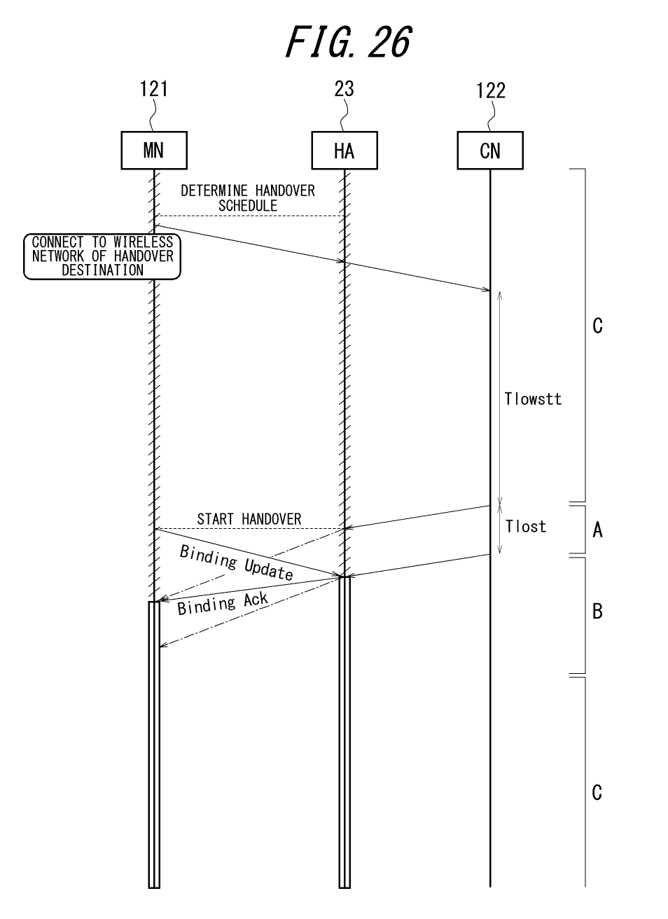

FIG. 26 is a diagram illustrating a summary of the data transmission processing by the telephone function unit 183 at handover. As described above, the packets transmitted from the communication apparatus (CN) 122 are lost in the packet loss period Tlost (period A) from the point to receive the handover notification message Msg(HO) from the wireless communication apparatus (MN) 121 to the point when the Tlowstt(sec) has passed thereafter. Therefore, in the period A, the telephone function unit 183 lowers the encoding bit-rate of the transmission data and transmits the data while accumulating copies of the data in the transmission buffer 157.

Subsequently, the telephone function unit 183, after transmission of packets through the handover destination is started, transmits the data in the transmission buffer 157 at a rapid speed until there is no packet in the transmission buffer 157, while accumulating new data in the transmission buffer 157 (period B). Then, until end of the communication or start of the period A for a next handover schedule, the telephone function unit 183 encodes the transmission data with the normal encoding bit-rate and transmits the transmission data without accumulating them in the transmission buffer 157 (period C).

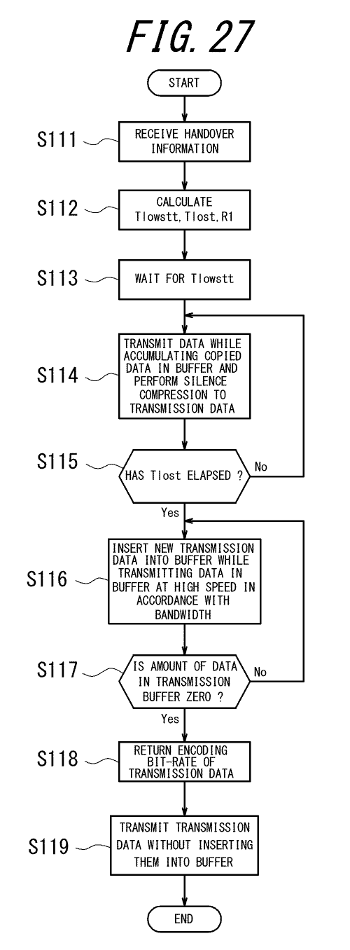

FIG. 27 is a flowchart illustrating operations of the transmission control unit 156 of the telephone function unit 183 at handover. The following is further detailed description of the data transmission processing of the telephone function unit 183 at handover, with reference to the flowchart shown in FIG. 27.

The handover information obtaining unit 155 of the telephone unit 183 monitors the handover information from the wireless communication apparatus (MN) 121 transferred from the HA 23, at predetermined intervals. If the handover schedule determination information is obtained as a result, the handover information obtaining unit 155 obtains the required handover information, that is, the handover preparation time Ts, the uplink and downlink absolute delay times Tdup1 and Tddn1 of the handover source, the uplink and downlink absolute delay times Tdup2 and Tddn2 of the handover destination and the expected bandwidth Rbdn2 of the handover destination (step S111) and provides the required information obtained to the transmission control unit 156.

After obtaining the handover information, the transmission control unit 156 first calculates the time Tlowstt, which is from the point to receive the handover notification message Msg(HO) to the period A in which packet loss occurs (see FIG. 26), the packet loss period Tlost, which is the period A, and the encoding bit-rate R1 (step S112).

Here, the time Tlowstt is calculated based on the above Formula 4, and the packet loss period Tlost is calculated by (Tddn1−Tddn2). In addition, as the encoding bit-rate R1, the maximum value among obtainable encoding bit-rates is selected with a smaller one as an upper limit between (i) Sbf/Tlost and (ii) Rbup2/Vf, where Rbdn2 (bps) represents the expected bandwidth obtained, Vf (sec/sec) represents the reproduction speed to the standard reproduction speed Vn of the application of the communication apparatus 122 after handover, Sbf (bit) represents a maximum capacity of the transmission buffer 157, Tlost (sec) represents the packet loss period, and Rn (bps) represents the standard encoding bit-rate. Here, as the encoding bit-rate to be selected, it is also possible to select a lower encoding bit-rate, so as to have some margin in consideration of variation in the bandwidth. In addition, the reproduction speed Vf after handover is set in advance as 1.25 times of the standard reproduction speed Vn, for example, and may be stored in both of the communication apparatuses or the communication apparatus 122 may notify the wireless communication apparatus 121 in advance.

Then, the transmission control unit 156 waits for the time Tlowstt (step S113) and, after the time Tlowstt has passed (start of the packet loss period Tlost), instructs the encoder 144 to lower the encoding bit-rate of the transmission data to the encoding bit-rate R1 calculated as well as providing the transmission data received from the encoder 144 to the packet transmission unit 145 as it stands, while copying the transmission data and accumulating the copies in the transmission buffer 157 (step S114). At this time, a silent part longer than a predetermined length (for example, 500 msec) in the transmission data is compressed to a predetermined length.

The processing at step S114 is performed until the packet loss period Tlost ends (step S115). When the packet loss period Tlost ends (Yes of S115, start of the period B), the transmission control unit 156, while accumulating the transmission data received from the encoder 144 in the transmission buffer 157 without providing the transmission data to the packet transmission unit 145, rapidly provides the data (packets) accumulated in the transmission buffer 157 to the packet transmission unit 145 in accordance with the bandwidth, from the oldest to the newest, so as to transmit the data to the wireless communication apparatus (MN) 121 (step S116).

The transmission control unit 156 monitors the number of packets in the transmission buffer 157 (step S117). When the number of packets in the transmission buffer 157 becomes zero as a result (Yes of S117, start of a period C), the transmission control unit 156 instructs the encoder 144 to return the encoding bit-rate to an original thereof (step S118) and provides the packet transmission unit 145 with the transmission data from the encoder 144 without accumulating them in the transmission buffer 157 so as to transmit the transmission data to the wireless communication apparatus (MN) 121 (step S119).

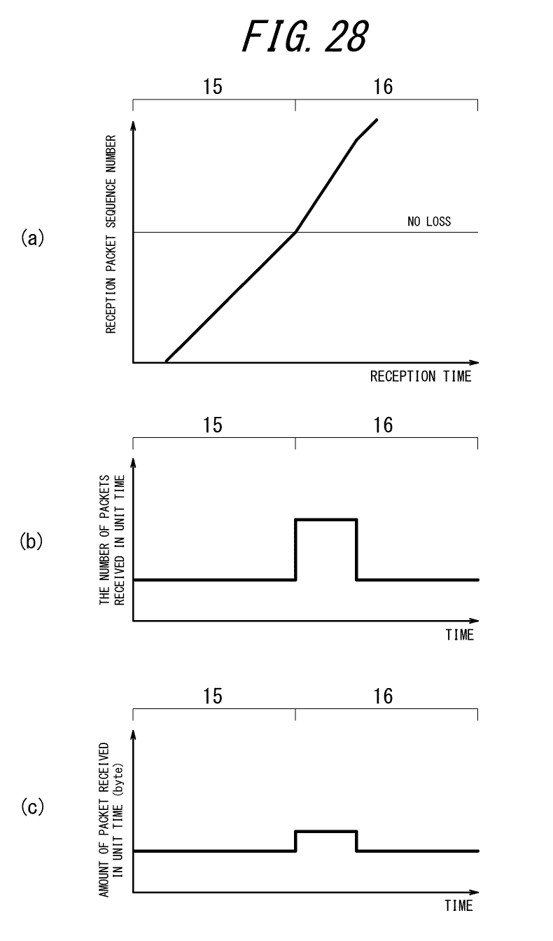

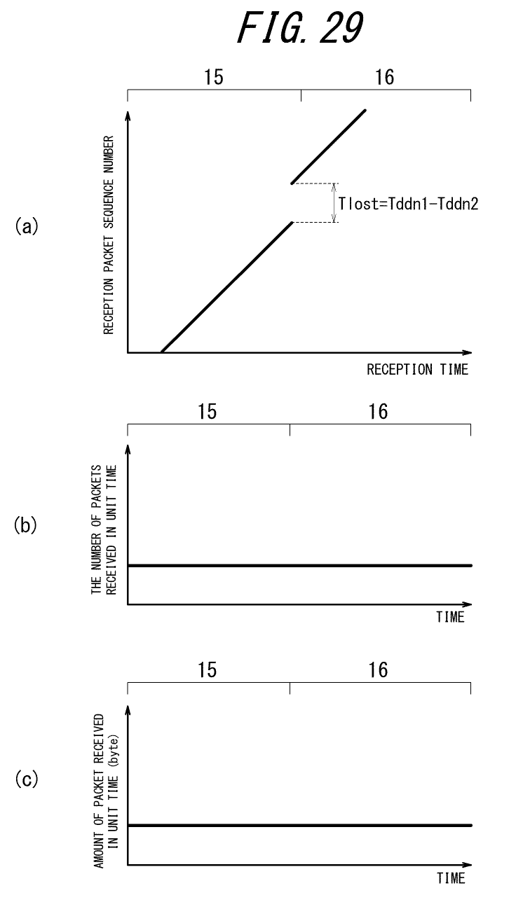

FIG. 28 is a diagram illustrating states of the reception packets of the wireless communication apparatus when the communication apparatus 122 according to the present embodiment performs transmission control at handover. FIG. 29 is a diagram, for comparison with FIG. 28, illustrating the states of the reception packets of the wireless communication apparatus when the transmission control is not performed at handover. In FIG. 28 and FIG. 29, (a) shows a sequence number of the reception packet; (b) shows the number of packets received in the unit time; and (c) shows an amount of the data (byte) received in the unit time.

As obvious from a comparison between FIG. 28 and FIG. 29, since the communication apparatus (CN) 122 according to the present embodiment accumulates packets expected to be lost by the wireless communication apparatus (MN) 121 at handover in the transmission buffer 157 and transmits the accumulated packets such that the wireless communication apparatus (MN) 121 can receive the packets after handover, the packet loss occurred in FIG. 29(a) does not occurs in FIG. 28(a). Accordingly, the wireless communication apparatus (MN) 121 which is a communication counterpart can maintain continuity of a sentence even at handover, and thus the user listening to voice will feel no sense of discomfort. In addition, since the communication apparatus (CN) 122 according to the present embodiment lowers the encoding bit-rate by the encoder 144 while the packets to be lost are accumulated, it is possible to transmit accumulated packets more than usual without causing congestion in the limited bandwidth. Accordingly, the wireless communication apparatus (MN) 121 on a reception side may return to reproduction with the original absolute delay by reproducing the packets received more than usual as shown in FIGS. 28(b) and (c) at a reproduction speed faster than usual. In addition, the communication apparatus (CN) 122 can reduce overall amount of the data by perform silence compression on the packets accumulated in the transmission buffer 157 and thereby transmit the accumulated packets much more rapidly.

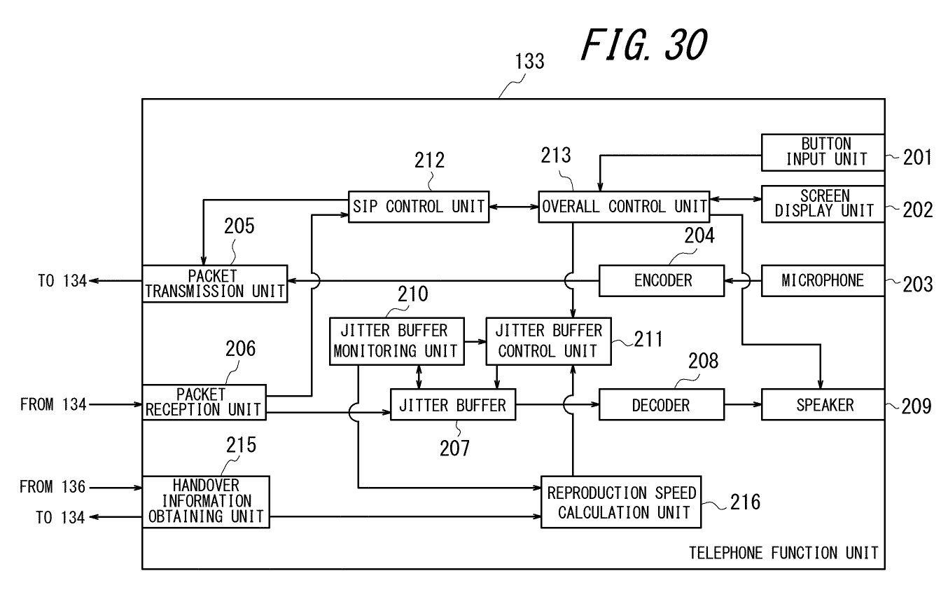

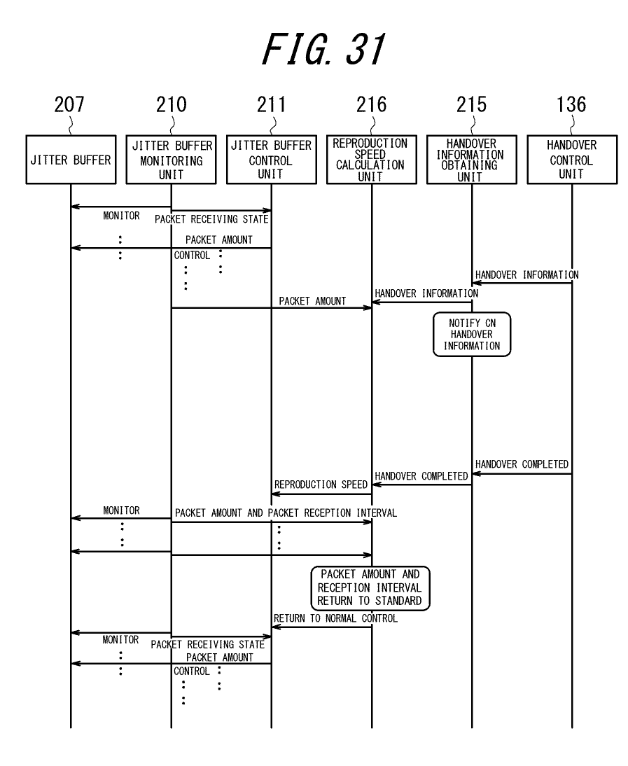

Next, the wireless communication apparatus (MN) 121 shown in FIG. 20 is described further in detail with reference to FIG. 30 and FIG. 31.

FIG. 30 is a functional block diagram illustrating a schematic constitution of the telephone function unit 133 of the wireless communication apparatus 121. FIG. 31 is a sequence diagram illustrating operations of a main section of the telephone function unit 133. As shown in FIG. 31, the telephone function unit 133 may be a known softphone, for example, and includes a button input unit 201, a screen display unit 202, a microphone 203, an encoder 204, a packet transmission unit 205, a packet reception unit 206, a jitter buffer 207, a decoder 208, a speaker 209, a jitter buffer monitoring unit 210, a jitter buffer control unit 211, an SIP control unit 212, and an overall control unit 213 for controlling the overall operation, in a similar manner as the telephone function unit 183 of the communication apparatus 122 shown in FIG. 25.

The overall control unit 213 obtains operation information of the user via the button input unit 201 or the screen display unit 202 and controls overall operations based on the operation information obtained. In addition, the SIP control unit 212 controls SIP procedure such as start or end of a call. During the call, voice data obtained by the microphone 203 are encoded by the encoder 204 and the data encoded are inserted into packets by the packet transmission unit 205 and then transmitted to the communication apparatus 122 via the communication processing unit 134.

In addition, the packets from the communication apparatus 122, received by the packet reception unit 206 via the communication processing unit 134, are read out after once stored in the jitter buffer 207. Payloads of the packets read out are decoded by the decoder 208 and output as reproduced voice from the speaker 209.

The jitter buffer monitoring unit 210 monitors the receiving states of the packets by the jitter buffer 207 and the number of packets (data amount) in the jitter buffer 207 as shown in FIG. 31. Based on a result of monitoring, the jitter buffer control unit 211 control the read-out speed of the packets from the jitter buffer 207 and a processing to discard the received packets.

The telephone function unit 133 of the wireless communication apparatus 121 shown in FIG. 20 further includes a handover information obtaining unit 215 and a reproduction speed calculation unit 216, as shown in FIG. 30. That is, the telephone function unit 133 has the same constitution as the telephone function unit 83 of the communication apparatus 12 shown in FIG. 14.

As shown in FIG. 31, the handover information obtaining unit 215 monitors the handover information from the handover control unit 136. If there is the handover information, the handover information obtaining unit 215 compares the downlink absolute delay time Tddn1 of the handover source and the downlink absolute delay time Tddn2 of the handover destination included in the handover information, as stated above. If Tddn1>Tddn2 is satisfied, the handover information obtaining unit 215 transmits the handover information as the handover notification message to the communication apparatus 122.

In addition, if the handover information is obtained and Tddn1>Tddn2 is satisfied, the handover information obtaining unit 215 further monitors the handover completion information included in the handover information and, when receiving the handover completion information, notifies the reproduction speed calculation unit 216 accordingly. Thereby, the reproduction speed calculation unit 216 notifies the jitter buffer control unit 211 to reproduce at the reproduction speed Vf (for example, 1.25 times of the standard reproduction speed Vn), which is faster than the standard reproduction speed Vn.

Subsequently, the reproduction speed calculation unit 216 obtains the amount of the packets accumulated in the jitter buffer 207 and the packet reception interval from the jitter buffer monitoring unit 210 at predetermined intervals. When the packet reception interval is longer than a certain value corresponding to the reception interval at the standard reproduction speed Vn and the amount of the packets accumulated becomes equal to or less than the standard amount of the accumulated packets, the reproduction speed calculation unit 216 instructs the jitter buffer control unit 211 to return to the normal reproduction speed.

If the downlink absolute delay time Tddn1 of the handover source and the downlink absolute delay time Tddn2 of the handover destination included in the handover information obtained satisfy Tddn1≦Tddn2, packet loss is not caused by the handover. Therefore, in this case, the handover information obtaining unit 215 does not transmit the handover notification message to the communication apparatus 122 and, after receiving the handover completion information, does not notifies the reproduction speed calculation unit 216 accordingly. Thus, in this case, the jitter buffer control unit 211 reproduces the packets in the jitter buffer 207 by the normal control based on the result of monitoring by the jitter buffer monitoring unit 210.

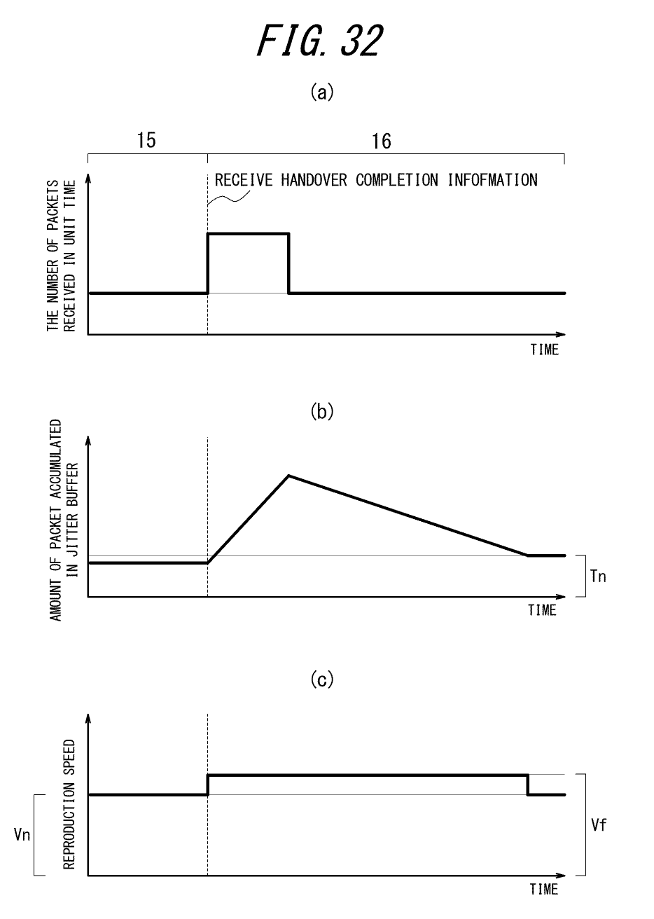

FIG. 32 is a diagram illustrating the reproduction control of the packets by the wireless communication apparatus 121 described above. FIG. 32(a) shows the number of packets received by the jitter buffer 207 in the unit time; FIG. 32(b) shows the amount of accumulated packets in the jitter buffer 207; and FIG. 32(c) shows the reproduction speed. As described above, the communication apparatus 122 accumulates the transmission data expected to be lost because of handover and, after handover is completed, transmits the data at a rapid speed at timing that the wireless communication apparatus 121 can receive the data.

Accordingly, as shown in FIG. 32(a), the number of packets received in the unit time is increased temporarily immediately after receiving the handover completion information from the HA 23 and, in accordance with such increase, the amount of accumulated packets in the jitter buffer 207 is increased gradually, as shown in FIG. 32(b). However, as shown in FIG. 32(c), when the handover completion information from the HA 23 is received, the reproduction speed is set to the reproduction speed Vf faster than the standard reproduction speed Vn, the amount of the accumulated packets in the jitter buffer 207 is decreased gradually, after the number of packets received in the unit time returns to the standard, and the reproduction speed returns to the standard reproduction speed Vn when the amount of the accumulated packets becomes the standard.

With the above processing, it is possible to reproduce the packets at an optimum speed by appropriately responding to a state that the accumulated packets arrives rapidly from the communication apparatus 122 after the handover completion information from the HA 23 is received.

As described above, after determining the handover schedule, the wireless communication apparatus (MN) 121 transmits the handover notification message to the communication apparatus (CN) 122 according to the present embodiment. Then, after receiving the handover notification message from the wireless communication apparatus 121, the communication apparatus 122 estimates the transmission data expected to be lost because of handover based on the handover information included in the handover notification message and accumulates such estimated transmission data in the transmission buffer 157 and then transmits the estimated transmission data to the wireless communication apparatus 121 at a speed in accordance with the wireless band after handover.

Here, start to accumulate the transmission data by the transmission buffer 157 is determined by the transmission control unit 156 which calculates an accumulation start timing of the transmission data expected to be lost, based on the timing of the handover notification message received. Therefore, in order to estimate more accurately and accumulate the packets expected to be lost, it is preferred to accurately match an accumulation start timing calculated by the transmission control unit 156 and a timing of packet loss caused by handover actually performed by the wireless communication apparatus 11. There may be considered two following methods to do so.

(1) Transmit an accumulation start message from the wireless communication apparatus 121 such that the accumulation start message arrives at the communication apparatus 122 at a timing that the transmission buffer 157 of the communication apparatus 122 starts accumulation processing.

(2) A timing cycle of the communication apparatus 122 is synchronized with that of the wireless communication apparatus 121.

When the above (1) is adopted, the accumulation start message may be transmitted from the wireless communication apparatus 121 to the communication apparatus 122 at a transmission delay time from the wireless communication apparatus 121 to the communication apparatus 122 before the accumulation start timing. By performing handover at a timing of the wireless communication apparatus 121 in this manner, there is no error in theory.

However, since handover is performed because a wireless communication state is deteriorating, packet congestion on the communication path is expected near a time to perform handover. If the packet congestion occurs, the accumulation start message stated above cannot reach the communication apparatus 122 at a scheduled timing because of congestion (congestion of the uplink from the wireless communication apparatus 121 to the communication apparatus 122 cannot be measured by the wireless communication apparatus 121).

In consideration of such condition, it is preferred that the wireless communication apparatus 121 transmits both the handover notification message beforehand and the accumulation start message immediately before, whereas the communication apparatus 122 monitors congestion from the receiving states of the packets and places a priority on the accumulation start message immediately before if it determines that there is no congestion, and starts accumulation at an accumulation start timing scheduled based on the handover notification message if it determines that there is congestion.

When the above (2) is adopted, it is necessary to synchronize the timing cycles of the wireless communication apparatus 121 and the communication apparatus 122 in advance. As a method to synchronize them, it may be considered to receive the radio states from the wireless communication apparatus 121 by the communication apparatus 122 for a predetermined period, measure a reception cycle of RTP packets in a state that it is determined that the radio state is good, and synchronize the timing cycle of the communication apparatus 122 with the wireless communication apparatus 121 by using the reception cycle measured as a correction cycle. Thereby, the communication apparatus 122 can start accumulation by correcting the accumulation start timing calculated by the wireless communication apparatus 121.

By correcting the timing cycle of the communication apparatus 122 by using the RTP packets from the wireless communication apparatus 121 in this manner, the timing cycles of the wireless communication apparatus 121 and the communication apparatus 122 can be synchronized with each other accurately, since when using the VoIP application, for example, the RTP packets of voice are transmitted at certain intervals basically and jitter is small in a good wireless condition.

In adopting either (1) or (2), if the handover schedule is changed on a side of the wireless communication apparatus 121, a message indicating accordingly is transmitted from the wireless communication apparatus 121 to the communication apparatus 122 so as to correct the operation of the communication apparatus 122 in accordance with change in the handover schedule. For example, if the wireless communication apparatus 121 detects congestion from the packets arriving at the wireless communication apparatus 121 after transmitting the handover notification message to the communication apparatus 122 and before handover, the wireless communication apparatus 121 transmits a message informing of congestion to the communication apparatus 122. In addition, if receiving the message informing of congestion before the accumulation start timing, the communication apparatus 122 further increases an expected accumulation capacity within a range not exceeding a predetermined maximum accumulation period (maximum capacity Sbf of the transmission buffer 157) and starts accumulation at timing before original accumulation start timing. Then, the communication apparatus 122 recalculates the encoding bit-rate in the accumulation period extended.

For example, in FIG. 23, if the packet loss is 200 (msec) because of a difference in transmission delay between the handover source and the handover destination at reception of the handover notification message Msg(HO), the accumulation period Tlost is set to 200 (msec). In this state, if the message indicating that congestion occurs from the wireless communication apparatus 121 is received at 500 (msec) before the accumulation start timing T1, the maximum accumulation period expected is 200+500=700 (msec). In this case, if the maximum capacity Sbf of the transmission buffer 157 is set to 500 (msec), accumulation is started at timing of (T1−300) (msec), an increased period 300 (msec) before a previous accumulation start timing T1, such that the accumulation period is 500 (msec).

If packet congestion occurs on the wireless path near handover as stated above, the packets including ones congested are accumulated and transmitted by using the path of the handover destination. Thereby, although it is not possible to compensate the wireless condition (intervals) itself due to congestion at the handover source, it is possible to reduce the number of packets lost in that time.

It is to be understood that the present invention is not limited to the above embodiments set forth above but may be modified or varied in a multiple of manners. For example, it is also possible to add the reproduction speed calculation unit 216 of the telephone function unit 133 of the wireless communication apparatus 121 shown in FIG. 30 to the telephone function unit 33 of the wireless communication apparatus 11 according to the first embodiment, so as to constitute a wireless communication apparatus capable of performing both the transmission control and the reproduction control stated above at handover. Similarly, it is also possible to add the reproduction speed calculation unit 116 of the telephone function unit 83 of the communication apparatus 12 shown in FIG. 14 to the telephone function unit 183 of the communication apparatus 122 according to the second embodiment, so as to constitute a communication apparatus capable of executing both the transmission control and the reproduction control stated above at handover.

In addition, the present invention is applicable not only when executing the VoIP application but also when executing an application for the real-time communication such as for streaming and reproducing multimedia data such as images and music. In such a case, the execution unit of the application may be constituted of a multimedia function unit having a similar transmission control function, instead of the telephone function unit. Moreover, the present invention is applicable not only to handover between CDMA2000 1xEV-DO and the wireless LAN but also to handover between arbitrary different wireless communication networks such as, for example, PDC (Personal Digital Cellular), W-CDMA (Wideband CDMA), PHS (Personal Handy-phone System), Bluetooth, WiMAX, LTE (Long Term Evolution), UMB (Ultra Mobile Broadband), IMT-Advanced, and the like.

1. A wireless communication apparatus comprising:
a wireless communication unit for executing wireless communication by connecting to a first wireless communication network and a second wireless communication network different from the first wireless communication network;
an execution unit for executing an application for real-time communication via the wireless communication unit;
a communication quality obtaining unit for obtaining communication quality of a wireless link in the first wireless communication network during execution of the application by connecting to the first wireless communication network;
a determination unit for determining whether to start handover preparation from the first wireless communication network to the second wireless communication network based on the communication quality obtained by the communication quality obtaining unit; and
a control unit, when the determination unit determines to start handover preparation, for controlling so as to transmit data via the first wireless communication network and accumulate the data for a predetermined period, and to transmit the accumulated data via the second wireless communication network after handover.

2. The wireless communication apparatus according to claim 1, further comprising an estimation unit, when the determination unit determines to start handover preparation during execution of the application, for estimating a handover preparation time before start of handover based on the communication quality obtained by the communication quality obtaining unit; and
a measuring unit, when the determination unit determines to start handover preparation, for measuring a delay time of each of the first wireless communication network and the second wireless communication network, wherein
the control unit determines a time to start accumulating the data based on the delay time of each of the first wireless communication network and the second wireless communication network measured by the measuring unit and the handover preparation time estimated by the estimation unit.

3. The wireless communication apparatus according to claim 1, further comprising a measuring unit, when the determination unit determines to start handover preparation, for measuring a delay time of each of the first wireless communication network and the second wireless communication network, wherein
the control unit determines the predetermined period to accumulate the data based on the delay time of each of the first wireless communication network and the second wireless communication network measured by the measuring unit.

4. The wireless communication apparatus according to claim 1, further comprising an encoding unit for encoding transmission data, wherein
the encoding unit encodes the data to be accumulated at a rate lower than an encoding bit-rate used before the determination unit determines to start handover preparation.

5. A communication apparatus comprising:
a communication unit for executing communication by connecting to a communication network;
an execution unit for executing an application for real-time communication via the communication unit; and
a control unit, if handover information that a wireless communication apparatus, which is a communication counterpart of the application, performs handover from a first wireless communication network being used for communication to a second wireless communication network different from the first wireless communication network is received from the wireless communication apparatus, for controlling so as to transmit data via the communication network and accumulate the data for a predetermined period, and to transmit the accumulated data to the wireless communication apparatus after handover of the wireless communication apparatus.

6. The communication apparatus according to claim 5, wherein the control unit determines a time to start accumulating the data based on a handover preparation time and a delay time of each of the first wireless communication network and the second wireless communication network, which are included in the handover information, and a delay time of the communication network.

7. The communication apparatus according to claim 5, wherein the control unit determines the predetermined period to accumulate the data based on a delay time of each of the first wireless communication network and the second wireless communication network included in the handover information.

8. The communication apparatus according to claim 6, wherein the control unit determines the predetermined period to accumulate the data based on a delay time of each of the first wireless communication network and the second wireless communication network included in the handover information.

9. The communication apparatus according to claim 5, further comprising an encoding unit for encoding transmission data, wherein
the encoding unit encodes the data to be accumulated at a rate lower than an encoding bit-rate used before the handover information is received.

10. The communication apparatus according to claim 6, further comprising an encoding unit for encoding transmission data, wherein
the encoding unit encodes the data to be accumulated at a rate lower than an encoding bit-rate used before the handover information is received.

11. The communication apparatus according to claim 7, further comprising an encoding unit for encoding transmission data, wherein
the encoding unit encodes the data to be accumulated at a rate lower than an encoding bit-rate used before the handover information is received.

12. The communication apparatus according to claim 8, further comprising an encoding unit for encoding transmission data, wherein
the encoding unit encodes the data to be accumulated at a rate lower than an encoding bit-rate used before the handover information is received.

13. The wireless communication apparatus according to claim 2, further comprising an encoding unit for encoding transmission data, wherein
the encoding unit encodes the data to be accumulated at a rate lower than an encoding bit-rate used before the determination unit determines to start handover preparation.

14. The wireless communication apparatus according to claim 3, further comprising an encoding unit for encoding transmission data, wherein
the encoding unit encodes the data to be accumulated at a rate lower than an encoding bit-rate used before the determination unit determines to start handover preparation.
